(19) United States
(12) Patent Application Publication
(10) Pub. No.: US 2026/0112004 A1
(43) Pub. Date: Apr. 23, 2026

(54) KERNEL BASED BLURRING

(71) Applicant: QUALCOMM Incorporated, San Diego, CA (US)

(72) Inventors: Navodit CHANDRA, Hyderabad (IN); Gururaj BHAT, Hyderabad (IN); Ashish MEDEWAR, Hyderabad (IN)

(21) Appl. No.: 18/922,132

(22) Filed: Oct. 21, 2024

(51) Int. Cl. G06T 5/70

(52) U.S. Cl. CPC G06T 5/70

(57) ABSTRACT

Systems and techniques are described herein for image processing. For example, a computing device can determine a characteristic of image data of an image. The computing device can determine, based on the characteristic of image data, a respective kernel from a plurality of kernels of different types to apply to each pixel of the image. The computing device can apply the respective kernel to each pixel of the image to generate a blurred output image.

### FIELD

The present disclosure generally relates to image processing. For example, aspects of the present disclosure relate to kernel-based blurring (e.g., efficient sparse kernel-based blurring).

### BACKGROUND

The increasing versatility of digital camera products has allowed digital cameras to be integrated into a wide array of devices and has expanded their use to different applications. For example, phones, drones, cars, computers, televisions, and many other devices today are often equipped with camera devices. The camera devices allow users to capture images and/or video (e.g., including frames of images) from any system equipped with a camera device. The images and/or videos can be captured for recreational use, professional photography, surveillance, and automation, among other applications. Moreover, camera devices are increasingly equipped with specific functionalities for modifying images or creating artistic effects on the images. For example, many camera devices are equipped with image processing capabilities for generating different effects on captured images.

Recently, there has been an increase in popularity of introducing bokeh (e.g., blur) effects into images. In photography, the term “bokeh” refers to the aesthetic quality of blur that is produced in out-of-focus parts of an image, whether in the foreground or background of the image, or both. Rendering of bokeh in images can be costly in terms of power consumption. As such, improved techniques for introducing bokeh in images with a reduced amount in the required power can be beneficial.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Disclosed are systems and techniques for image processing. In some aspects, an apparatus for image processing is provided. The apparatus includes at least one memory and at least one processor coupled to the at least one memory and configured to: determine a characteristic of image data of an image; based on the characteristic of image data, determine a respective kernel from a plurality of kernels of different types to apply to each pixel of the image; and apply the respective kernel to each pixel of the image to generate a blurred output image.

In some aspects, a method for image processing is provided. The method includes: determining a characteristic of image data of an image; based on the characteristic of image data, determining a respective kernel from a plurality of kernels of different types to apply to each pixel of the image; and applying the respective kernel to each pixel of the image to generate a blurred output image.

In some aspects, a non-transitory computer-readable medium is provided having stored thereon instructions that, when executed by at least one processor, cause the at least one processor to: determine a characteristic of image data of an image; based on the characteristic of image data, determine a respective kernel from a plurality of kernels of different types to apply to each pixel of the image; and apply the respective kernel to each pixel of the image to generate a blurred output image.

In some aspects, an apparatus for image processing is provided. The apparatus includes: means for determining a characteristic of image data of an image; means for determining, based on the characteristic of image data, a respective kernel from a plurality of kernels of different types to apply to each pixel of the image; and means for applying the respective kernel to each pixel of the image to generate a blurred output image.

In some aspects, one or more of the apparatuses described herein is, can be part of, or can include an extended reality (XR) device (e.g., a virtual reality (VR) device, an augmented reality (AR) device, or a mixed reality (MR) device), a mobile device (e.g., a mobile telephone or so-called “smart phone”, a tablet computer, or other type of mobile device), a smart or connected device (e.g., an Internet-of-Things (IoT) device), a wearable device, a personal computer, a laptop computer, a video server, a television (e.g., a network-connected television), a vehicle (or a computing device, system, or component of a vehicle), a robotics device or system, or other device. In some aspects, each apparatus can include an image sensor (e.g., a camera) or multiple image sensors (e.g., multiple cameras) for capturing one or more images. In some aspects, each apparatus can include one or more displays for displaying one or more images, notifications, and/or other displayable data. In some aspects, each apparatus can include one or more speakers, one or more light-emitting devices, and/or one or more microphones. In some aspects, each apparatus can include one or more sensors. In some cases, the one or more sensors can be used for determining a location of the apparatuses, a state of the apparatuses (e.g., a tracking state, an operating state, a temperature, a humidity level, and/or other state), and/or for other purposes.

Some aspects include a device having a processor (or multiple processors) configured to perform one or more operations of any of the methods summarized above. In some cases, the processor(s) can include a neural processing unit (NPU), a neural signal processor (NSP), a digital signal processor (DSP), a graphics processing unit (GPU), a central processing unit (CPU), any combination thereof, and/or other processor(s). Further aspects include processing devices for use in a device configured with processor-executable instructions to perform operations of any of the methods summarized above. Further aspects include a non-transitory processor-readable storage medium having stored thereon processor-executable instructions configured to cause a processor of a device to perform operations of any of the methods summarized above. Further aspects include a device having means for performing functions of any of the methods summarized above.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims. The foregoing, together with other features and aspects, will become more apparent upon referring to the following specification, claims, and accompanying drawings.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The preceding, together with other features and embodiments, will become more apparent upon referring to the following specification, claims, and accompanying drawings.

### BRIEF DESCRIPTION OF THE DRAWINGS

Illustrative aspects of the present application are described in detail below with reference to the following figures:

FIG. 1 is a block diagram illustrating an architecture of an image capture and processing system, in accordance with some aspects of the disclosure.

FIG. 2 is a block diagram illustrating an example of a deep learning network, in accordance with some aspects of the disclosure.

FIG. 3 is a block diagram illustrating an example of a convolutional neural network, in accordance with some aspects of the disclosure.

FIG. 4 is a diagram illustrating an example of a convolutional operation using a kernel to render bokeh (e.g., blur) in an image, in accordance with some aspects of the disclosure.

FIG. 5 is a diagram illustrating an example of a blur map generated based on an image, in accordance with some aspects of the disclosure.

FIG. 6 is a diagram illustrating an example of dense kernels, in accordance with some aspects of the disclosure.

FIG. 7 is a diagram illustrating an example of a dense kernel and a sparse kernel, in accordance with some aspects of the disclosure.

FIG. 8 is a diagram illustrating an example of a pixel with neighboring pixels located on a horizonal axis and a vertical axis, in accordance with some aspects of the disclosure.

FIG. 9 is a diagram illustrating an example of a pixel with neighboring pixels located on diagonal axes, in accordance with some aspects of the disclosure.

FIG. 10 is a diagram illustrating an example of a pixel with neighboring pixels located on a horizonal axis, a vertical axis, and diagonal axes, in accordance with some aspects of the disclosure.

FIG. 11 is a diagram illustrating an example of a process for efficient sparse kernel based blurring, in accordance with some aspects of the disclosure.

FIG. 12 is a diagram illustrating an example of regions (e.g., which are not on the focal plane) where a one by one matrix kernel is used and a sparse kernel is used, respectively, in accordance with some aspects of the disclosure.

FIG. 13 is a diagram illustrating an example of bokeh frames for shallow depth of field rendering where a dense kernel is used and a combination of a dense kernel and a sparse kernel are used, respectively, in accordance with some aspects of the disclosure.

FIG. 14 is a diagram illustrating an example of bokeh frames for shallow depth of field rendering where a dense kernel is used and a combination of a dense kernel and a sparse kernel are used, respectively, in accordance with some aspects of the disclosure.

FIG. 15 is a diagram illustrating an example of box blurred frames where a dense kernel is used and a combination of a dense kernel and a sparse kernel are used, respectively, in accordance with some aspects of the disclosure.

FIG. 16 is a diagram illustrating an example of box blurred frames where a dense kernel is used and a combination of a dense kernel and a sparse kernel are used, respectively, in accordance with some aspects of the disclosure.

FIG. 17 is a diagram illustrating examples of bokeh frames for shallow depth of field rendering where a dense kernel was used and a sparse kernel was used, respectively, in accordance with some aspects of the disclosure.

FIG. 18 is a diagram illustrating examples of bokeh frames for shallow depth of field rendering where a dense kernel was used and a combination of a dense kernel and a sparse kernel was used, respectively, in accordance with some aspects of the disclosure.

FIG. 19 is a flow diagram illustrating an example of a process for image processing, in accordance with some aspects of the disclosure.

FIG. 20 is a diagram illustrating an example of a system for implementing certain aspects described herein.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein can be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

A camera is a device that receives light and captures image frames, such as still images or video frames, using an image sensor. The terms “image,” “image frame,” and “frame” are used interchangeably herein. Cameras may include processors, such as image signal processors (ISPs), that can receive one or more image frames and process the one or more image frames. For example, a raw image frame captured by a camera sensor can be processed by an ISP to generate a final image. Processing by the ISP can be performed by a plurality of filters or processing blocks being applied to the captured image frame, such as denoising or noise filtering, edge enhancement, color balancing, contrast, intensity adjustment (such as darkening or lightening), tone adjustment, among others. Image processing blocks or modules may include lens/sensor noise correction, Bayer filters, de-mosaicing, color conversion, correction or enhancement/suppression of image attributes, denoising filters, sharpening filters, among others.

Cameras can be configured with a variety of image capture and image processing operations and settings. The different settings result in images with different appearances. Some camera operations are determined and applied before or during capture of the image, such as automatic exposure control (AEC) and automatic white balance (AWB) processing. Additional camera operations applied before, during, or after capture of an image include operations involving zoom (e.g., zooming in or out), ISO, aperture size, f/stop, shutter speed, and gain. Other camera operations can configure post-processing of an image, such as alterations to contrast, brightness, saturation, sharpness, levels, curves, or colors.

As previously mentioned, recently, there has been an increase in popularity of introducing bokeh (e.g., blur) effects into images (e.g., snapshot bokeh) or into video including a plurality of images (e.g., video bokeh). In photography, the term “bokeh” refers to the aesthetic quality of blur that is produced in out-of-focus parts of an image, whether in the foreground or background of the image, or both. The root of the word “bokeh” is from the Japanese word “boke,” which means “blur” or “haze.” The word “bokeh” results from “boke-aji” in Japanese meaning “blur quality.”

Bokeh can be introduced into an image by convolving the image with a kernel that corresponds to the image of an out-of-focus point source taken with a camera. Unlike conventional convolution, this type of convolution uses a kernel that depends upon the distance of each point in the image. Bokeh is a defocusing blur that can be achieved by performing convolution with a uniform disk (e.g., a bokeh disc) to produce a soft effect of circles around highlights within the image.

Real time rendering of bokeh effects in video frames at thirty (30) or higher frames per second (FPS) involves a significant amount of overhead in terms of time and power (e.g., especially on low end devices), if dense kernels are used to obtain blurred intensities for all pixels not lying on the focal plane. Increased bokeh render time can reduce the amount of bandwidth (e.g., in terms of time) remaining for performance of other tasks (e.g., depth perception, warping, etc.) in the bokeh pipeline, which can lead to a drop in the FPS. Since bokeh rendering involves a large number of floating-point operations, real-time rendering of bokeh requires a large power overhead, unless there is some dedicated hardware to render the bokeh. As such, rendering of bokeh in images (or video) using dense kernels can be costly in terms of power consumption.

Therefore, improved systems and techniques for introducing bokeh in images or video with a reduced amount in the required power can be beneficial.

In one or more aspects of the present disclosure, systems, apparatuses, methods (also referred to as processes), and computer-readable media (collectively referred to herein as “systems and techniques”) are described herein that provide solutions for efficient sparse kernel based blurring (without the inclusion of artifacts) in images and video.

The power and compute requirements for producing real time bokeh effects (e.g., for preview and streaming for snapshot or video recording) are significant. To reduce power and compute requirements, a sparse kernel may be employed instead of a dense kernel. Using a sparse kernel (e.g., a sparsely populated kernel) instead of a dense kernel (e.g., a densely populate kernel) requires significantly less read-write and compute requirements for producing bokeh. However, using a sparse kernel at all pixel positions can result in undesirable artifacts in the image or video.

In one or more examples, the systems and techniques provide depth and content guided selection of a sparse kernel or dense kernel to produce a final rendering of bokeh effects that is free of undesirable artifacts. The application of a sparse kernel for convolution is not limited to shallow depth of field rendering, and can be extended to other forms of blurring (e.g., filtering) where the kernels have uniform values.

In some examples, the systems and techniques provide solutions that select, depending upon image data, between different types of kernels (e.g., a dense kernel, a sparse kernel, or a one by one matrix kernel) for using to render bokeh in an image or video. A first kernel type (e.g., a one by one matrix kernel) can be applied when intensity and disparity values for a given pixel match (or are similar to) the values of radial neighboring pixels (e.g., four neighboring pixels). A second kernel type (e.g., a sparse kernel) can be applied when pixel intensity values in a neighborhood of pixels are within an intensity threshold value of a given pixel and a blur radius is greater than or equal to a blur radius threshold (e.g., which may be 0.5 times a maximum blur radius). Lastly, a third kernel type (e.g., a dense kernel) can be used in other circumstances.

In one or more aspects, during operation of a method for image processing, one or more processors can determine a characteristic of image data of an image. Based on the characteristic of image data, the one or more processors can determine a respective kernel from a plurality of kernels of different types to apply to each pixel of the image. The one or more processors can apply the respective kernel to each pixel of the image to generate a blurred output image.

In one or more examples, the plurality of kernels of different types can include at least a dense kernel, a sparse kernel comprising less number of pixels than the dense kernel, and a one by one (1×1) matrix kernel comprising one value. In some examples, the characteristic of the image data can include a disparity of pixels in the image, an intensity of the pixels in the image, and/or a respective blur radius for each of the pixels in the image.

In one or more examples, determining the respective kernel for each pixel of the image based on the characteristic of the image data can include determining, by the one or more processors, a difference in the disparity of each of the pixels in the image and a respective plurality of neighboring pixels of each of the pixels. In some examples, determining the difference in the disparity of each of the pixels in the image and the respective plurality of neighboring pixels of each of the pixels can include determining the difference in the disparity is less than a disparity threshold.

In some examples, the respective plurality of neighboring pixels of each of the pixels can include a first number of pixels located on a horizontal axis and a vertical axis around an associated pixel of the pixels, a second number of pixels located on diagonal axes around the associated pixel of the pixels, or a third number of pixels located on the horizontal axis, the vertical axis, and the diagonal axes around the associated pixel of the pixels.

In one or more examples, determining the respective kernel for each pixel of the image based on the characteristic of the image data can include determining, by the one or more processors, a difference in the intensity of each of the pixels in the image and a respective plurality of neighboring pixels of each of the pixels. In one or more examples, determining the difference in the intensity of each of the pixels in the image and the respective plurality of neighboring pixels of each of the pixels can include determining, by the one or more processors, the difference in the intensity is less than an intensity threshold. In some examples, determining the difference in the intensity of each of the pixels in the image and the respective plurality of neighboring pixels of each of the pixels can be based on determining a cosine similarity, a mean squared error, a mean absolute error, or a standard deviation between the intensity of each of the pixels in the image and the intensity of the respective plurality of neighboring pixels of each of the pixels.

In some examples, the one or more processors can apply a one by one matrix kernel to a pixel of the image based on a determination that a difference in a disparity of the pixel in the image and the respective plurality of neighboring pixels of the pixel is less than the disparity threshold and a difference in an intensity of the pixel in the image and the respective plurality of neighboring pixels of the pixel is less than the intensity threshold. In one or more examples, the one or more processors can apply a dense kernel to a pixel of the image based on a determination that a difference in the disparity of the pixel in the image and the respective plurality of neighboring pixels of the pixel is not less than the disparity threshold or a difference in an intensity of the pixel in the image and the respective plurality of neighboring pixels of the pixel is not less than the intensity threshold.

In one or more examples, the one or more processors can apply a sparse kernel to a pixel of the image based on a determination that a difference in an intensity of the pixel in the image and the respective plurality of neighboring pixels of the pixel is less than the intensity threshold and the respective blur radius of the pixel is greater than or equal to the blur radius threshold. In some examples, the one or more processors can apply a dense kernel to a pixel of the image based on a determination that a difference in an intensity of the pixel in the image and the respective plurality of neighboring pixels of the pixel is not less than the intensity threshold or the respective blur radius of the pixel is not greater than or equal to the blur radius threshold.

In some examples, determining the respective kernel for each pixel of the image based on the characteristic of the image data can include determining the respective blur radius of each of the pixels is greater than or equal to a blur radius threshold. In one or more examples, the blur radius threshold can be equal to one-half of a maximum blur radius.

Particular aspects of the subject matter described in this disclosure can be implemented to realize one or more of the following potential advantages. In one or more examples, the systems and techniques can provide a benefit of reducing power and compute requirements for rendering bokeh in images and video by using a sparse kernel for some of the pixels of the images and video for the rendering of bokeh.

Additional aspects of the present disclosure are described in more detail below.

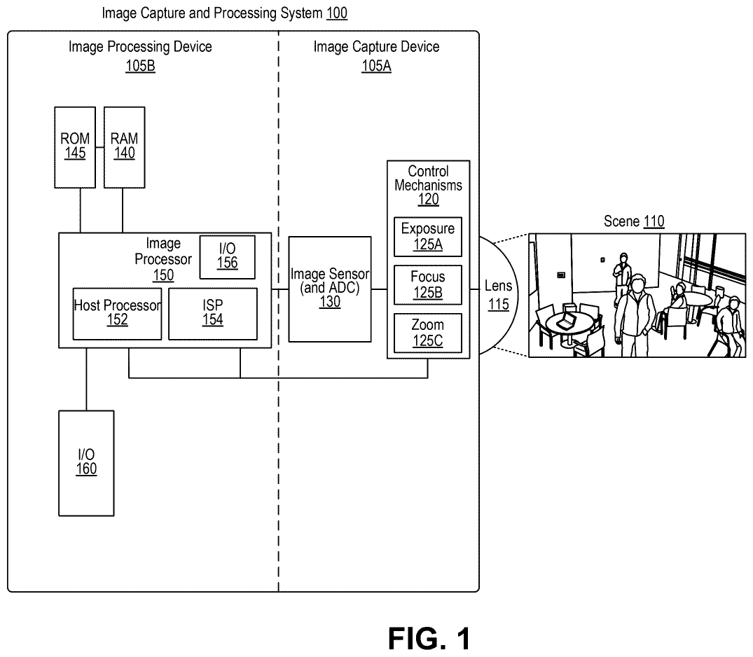

FIG. 1 is a block diagram illustrating an architecture of an image capture and processing system 100. The image capture and processing system 100 includes various components that are used to capture and process images of scenes (e.g., an image of a scene 110). The image capture and processing system 100 can capture standalone images (or photographs) and/or can capture videos that include multiple images (or video frames) in a particular sequence. In some cases, the lens 115 and image sensor 130 can be associated with an optical axis. In one illustrative example, the photosensitive area of the image sensor 130 (e.g., the photodiodes) and the lens 115 can both be centered on the optical axis. A lens 115 of the image capture and processing system 100 faces a scene 110 and receives light from the scene 110. The lens 115 bends incoming light from the scene toward the image sensor 130. The light received by the lens 115 passes through an aperture. In some cases, the aperture (e.g., the aperture size) is controlled by one or more control mechanisms 120 and is received by an image sensor 130. In some cases, the aperture can have a fixed size.

The one or more control mechanisms 120 may control exposure, focus, and/or zoom based on information from the image sensor 130 and/or based on information from the image processor 150. The one or more control mechanisms 120 may include multiple mechanisms and components; for instance, the control mechanisms 120 may include one or more exposure control mechanisms 125A, one or more focus control mechanisms 125B, and/or one or more zoom control mechanisms 125C. The one or more control mechanisms 120 may also include additional control mechanisms besides those that are illustrated, such as control mechanisms controlling analog gain, flash, HDR, depth of field, and/or other image capture properties.

The focus control mechanism 125B of the control mechanisms 120 can obtain a focus setting. In some examples, focus control mechanism 125B store the focus setting in a memory register. Based on the focus setting, the focus control mechanism 125B can adjust the position of the lens 115 relative to the position of the image sensor 130. For example, based on the focus setting, the focus control mechanism 125B can move the lens 115 closer to the image sensor 130 or farther from the image sensor 130 by actuating a motor or servo (or other lens mechanism), thereby adjusting focus. In some cases, additional lenses may be included in the image capture and processing system 100, such as one or more microlenses over each photodiode of the image sensor 130, which each bend the light received from the lens 115 toward the corresponding photodiode before the light reaches the photodiode. The focus setting may be determined via contrast detection autofocus (CDAF), phase detection autofocus (PDAF), hybrid autofocus (HAF), or some combination thereof. The focus setting may be determined using the control mechanism 120, the image sensor 130, and/or the image processor 150. The focus setting may be referred to as an image capture setting and/or an image processing setting. In some cases, the lens 115 can be fixed relative to the image sensor and focus control mechanism 125B can be omitted without departing from the scope of the present disclosure.

The exposure control mechanism 125A of the control mechanisms 120 can obtain an exposure setting. In some cases, the exposure control mechanism 125A stores the exposure setting in a memory register. Based on this exposure setting, the exposure control mechanism 125A can control a size of the aperture (e.g., aperture size or f/stop), a duration of time for which the aperture is open (e.g., exposure time or shutter speed), a duration of time for which the sensor collects light (e.g., exposure time or electronic shutter speed), a sensitivity of the image sensor 130 (e.g., ISO speed or film speed), analog gain applied by the image sensor 130, or any combination thereof. The exposure setting may be referred to as an image capture setting and/or an image processing setting.

The zoom control mechanism 125C of the control mechanisms 120 can obtain a zoom setting. In some examples, the zoom control mechanism 125C stores the zoom setting in a memory register. Based on the zoom setting, the zoom control mechanism 125C can control a focal length of an assembly of lens elements (lens assembly) that includes the lens 115 and one or more additional lenses. For example, the zoom control mechanism 125C can control the focal length of the lens assembly by actuating one or more motors or servos (or other lens mechanism) to move one or more of the lenses relative to one another. The zoom setting may be referred to as an image capture setting and/or an image processing setting. In some examples, the lens assembly may include a parfocal zoom lens or a varifocal zoom lens. In some examples, the lens assembly may include a focusing lens (which can be lens 115 in some cases) that receives the light from the scene 110 first, with the light then passing through an afocal zoom system between the focusing lens (e.g., lens 115) and the image sensor 130 before the light reaches the image sensor 130. The afocal zoom system may, in some cases, include two positive (e.g., converging, convex) lenses of equal or similar focal length (e.g., within a threshold difference of one another) with a negative (e.g., diverging, concave) lens between them. In some cases, the zoom control mechanism 125C moves one or more of the lenses in the afocal zoom system, such as the negative lens and one or both of the positive lenses. In some cases, zoom control mechanism 125C can control the zoom by capturing an image from an image sensor of a plurality of image sensors (e.g., including image sensor 130) with a zoom corresponding to the zoom setting. For example, image processing system 100 can include a wide angle image sensor with a relatively low zoom and a telephoto image sensor with a greater zoom. In some cases, based on the selected zoom setting, the zoom control mechanism 125C can capture images from a corresponding sensor.

The image sensor 130 includes one or more arrays of photodiodes or other photosensitive elements. Each photodiode measures an amount of light that eventually corresponds to a particular pixel in the image produced by the image sensor 130. In some cases, different photodiodes may be covered by different filters. In some cases, different photodiodes can be covered in color filters, and may thus measure light matching the color of the filter covering the photodiode. Various color filter arrays can be used, including a Bayer color filter array, a quad color filter array (also referred to as a quad Bayer color filter array or QCFA), and/or any other color filter array. For instance, Bayer color filters include red color filters, blue color filters, and green color filters, with each pixel of the image generated based on red light data from at least one photodiode covered in a red color filter, blue light data from at least one photodiode covered in a blue color filter, and green light data from at least one photodiode covered in a green color filter.

Returning to FIG. 1, other types of color filters may use yellow, magenta, and/or cyan (also referred to as “emerald”) color filters instead of or in addition to red, blue, and/or green color filters. In some cases, some photodiodes may be configured to measure infrared (IR) light. In some implementations, photodiodes measuring IR light may not be covered by any filter, thus allowing IR photodiodes to measure both visible (e.g., color) and IR light. In some examples, IR photodiodes may be covered by an IR filter, allowing IR light to pass through and blocking light from other parts of the frequency spectrum (e.g., visible light, color). Some image sensors (e.g., image sensor 130) may lack filters (e.g., color, IR, or any other part of the light spectrum) altogether and may instead use different photodiodes throughout the pixel array (in some cases vertically stacked). The different photodiodes throughout the pixel array can have different spectral sensitivity curves, therefore responding to different wavelengths of light. Monochrome image sensors may also lack filters and therefore lack color depth.

In some cases, the image sensor 130 may alternately or additionally include opaque and/or reflective masks that block light from reaching certain photodiodes, or portions of certain photodiodes, at certain times and/or from certain angles. In some cases, opaque and/or reflective masks may be used for phase detection autofocus (PDAF). In some cases, the opaque and/or reflective masks may be used to block portions of the electromagnetic spectrum from reaching the photodiodes of the image sensor (e.g., an IR cut filter, a UV cut filter, a band-pass filter, low-pass filter, high-pass filter, or the like). The image sensor 130 may also include an analog gain amplifier to amplify the analog signals output by the photodiodes and/or an analog to digital converter (ADC) to convert the analog signals output of the photodiodes (and/or amplified by the analog gain amplifier) into digital signals. In some cases, certain components or functions discussed with respect to one or more of the control mechanisms 120 may be included instead or additionally in the image sensor 130. The image sensor 130 may be a charge-coupled device (CCD) sensor, an electron-multiplying CCD (EMCCD) sensor, an active-pixel sensor (APS), a complimentary metal-oxide semiconductor (CMOS), an N-type metal-oxide semiconductor (NMOS), a hybrid CCD/CMOS sensor (e.g., sCMOS), or some other combination thereof.

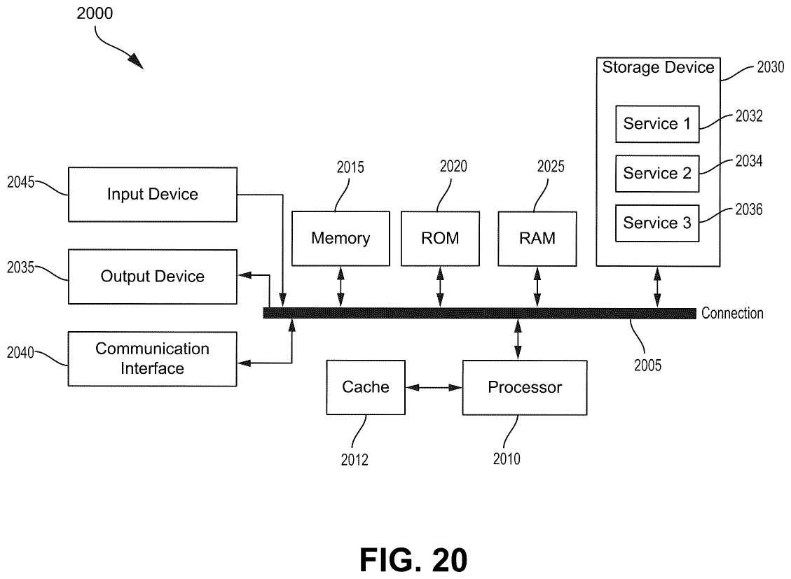

The image processor 150 may include one or more processors, such as one or more image signal processors (ISPs) (including ISP 154), one or more host processors (including host processor 152), and/or one or more of any other type of processor 2010 discussed with respect to the computing system 2000 of FIG. 20. The host processor 152 can be a digital signal processor (DSP) and/or other type of processor. In some implementations, the image processor 150 is a single integrated circuit or chip (e.g., referred to as a system-on-chip or SoC) that includes the host processor 152 and the ISP 154. In some cases, the chip can also include one or more input/output ports (e.g., input/output (I/O) ports 156), central processing units (CPUs), graphics processing units (GPUs), broadband modems (e.g., 3G, 4G or LTE, 5G, etc.), memory, connectivity components (e.g., Bluetooth™, Global Positioning System (GPS), etc.), any combination thereof, and/or other components. The I/O ports 156 can include any suitable input/output ports or interface according to one or more protocol or specification, such as an Inter-Integrated Circuit 2 (I2C) interface, an Inter-Integrated Circuit 3 (I3C) interface, a Serial Peripheral Interface (SPI) interface, a serial General Purpose Input/Output (GPIO) interface, a Mobile Industry Processor Interface (MIPI) (such as a MIPI CSI-2 physical (PHY) layer port or interface, an Advanced High-performance Bus (AHB) bus, any combination thereof, and/or other input/output port. In one illustrative example, the host processor 152 can communicate with the image sensor 130 using an I2C port, and the ISP 154 can communicate with the image sensor 130 using an MIPI port.

The image processor 150 may perform a number of tasks, such as de-mosaicing, color space conversion, image frame downsampling, pixel interpolation, automatic exposure (AE) control, automatic gain control (AGC), CDAF, PDAF, automatic white balance, merging of image frames to form an HDR image, image recognition, object recognition, feature recognition, receipt of inputs, managing outputs, managing memory, or some combination thereof. The image processor 150 may store image frames and/or processed images in random access memory (RAM) 140/2025, read-only memory (ROM) 145/2020, a cache, a memory unit, another storage device, or some combination thereof.

Various input/output (I/O) devices 160 may be connected to the image processor 150. The I/O devices 160 can include a display screen, a keyboard, a keypad, a touchscreen, a trackpad, a touch-sensitive surface, a printer, any other output devices 1035, any other input devices 1045, or some combination thereof. In some cases, a caption may be input into the image processing device 105B through a physical keyboard or keypad of the I/O devices 160, or through a virtual keyboard or keypad of a touchscreen of the I/O devices 160. The I/O devices 160 may include one or more ports, jacks, or other connectors that enable a wired connection between the image capture and processing system 100 and one or more peripheral devices, over which the image capture and processing system 100 may receive data from the one or more peripheral device and/or transmit data to the one or more peripheral devices. The I/O devices 160 may include one or more wireless transceivers that enable a wireless connection between the image capture and processing system 100 and one or more peripheral devices, over which the image capture and processing system 100 may receive data from the one or more peripheral device and/or transmit data to the one or more peripheral devices. The peripheral devices may include any of the previously discussed types of I/O devices 160 and may themselves be considered I/O devices 160 once they are coupled to the ports, jacks, wireless transceivers, or other wired and/or wireless connectors.

In some cases, the image capture and processing system 100 may be a single device. In some cases, the image capture and processing system 100 may be two or more separate devices, including an image capture device 105A (e.g., a camera) and an image processing device 105B (e.g., a computing device coupled to the camera). In some implementations, the image capture device 105A and the image processing device 105B may be coupled together, for example via one or more wires, cables, or other electrical connectors, and/or wirelessly via one or more wireless transceivers. In some implementations, the image capture device 105A and the image processing device 105B may be disconnected from one another.

As shown in FIG. 1, a vertical dashed line divides the image capture and processing system 100 of FIG. 1 into two portions that represent the image capture device 105A and the image processing device 105B, respectively. The image capture device 105A includes the lens 115, control mechanisms 120, and the image sensor 130. The image processing device 105B includes the image processor 150 (including the ISP 154 and the host processor 152), the RAM 140, the ROM 145, and the I/O devices 160. In some cases, certain components illustrated in the image capture device 105A, such as the ISP 154 and/or the host processor 152, may be included in the image capture device 105A.

The image capture and processing system 100 can include an electronic device, such as a mobile or stationary telephone handset (e.g., smartphone, cellular telephone, or the like), a desktop computer, a laptop or notebook computer, a tablet computer, a set-top box, a television, a camera, a display device, a digital media player, a video gaming console, a video streaming device, an Internet Protocol (IP) camera, or any other suitable electronic device. In some examples, the image capture and processing system 100 can include one or more wireless transceivers for wireless communications, such as cellular network communications, 802.11 wi-fi communications, wireless local area network (WLAN) communications, or some combination thereof. In some implementations, the image capture device 105A and the image processing device 105B can be different devices. For instance, the image capture device 105A can include a camera device and the image processing device 105B can include a computing device, such as a mobile handset, a desktop computer, or other computing device.

While the image capture and processing system 100 is shown to include certain components, one of ordinary skill will appreciate that the image capture and processing system 100 can include more components than those shown in FIG. 1. The components of the image capture and processing system 100 can include software, hardware, or one or more combinations of software and hardware. For example, in some implementations, the components of the image capture and processing system 100 can include and/or can be implemented using electronic circuits or other electronic hardware, which can include one or more programmable electronic circuits (e.g., microprocessors, GPUs, DSPs, CPUs, and/or other suitable electronic circuits), and/or can include and/or be implemented using computer software, firmware, or any combination thereof, to perform the various operations described herein. The software and/or firmware can include one or more instructions stored on a computer-readable storage medium and executable by one or more processors of the electronic device implementing the image capture and processing system 100.

Machine learning (ML) can be considered a subset of artificial intelligence (AI). ML systems can include algorithms and statistical models that computer systems can use to perform various tasks by relying on patterns and inference, without the use of explicit instructions. An example of a ML system is a neural network (also referred to as an artificial neural network), which may include an interconnected group of artificial neurons (e.g., neuron models). Neural networks may be used for various applications and/or devices, such as image and/or video coding, image analysis and/or computer vision applications, Internet Protocol (IP) cameras, Internet of Things (IoT) devices, autonomous vehicles, service robots, among others.

Individual nodes in a neural network may emulate biological neurons by taking input data and performing simple operations on the data. The results of the simple operations performed on the input data are selectively passed on to other neurons. Weight values are associated with each vector and node in the network, and these values constrain how input data is related to output data. For example, the input data of each node may be multiplied by a corresponding weight value, and the products may be summed. The sum of the products may be adjusted by an optional bias, and an activation function may be applied to the result, yielding the node's output signal or “output activation” (sometimes referred to as a feature map or an activation map). The weight values may initially be determined by an iterative flow of training data through the network (e.g., weight values are established during a training phase in which the network learns how to identify particular classes by their typical input data characteristics).

Different types of neural networks exist, such as convolutional neural networks (CNNs), recurrent neural networks (RNNs), generative adversarial networks (GANs), multilayer perceptron (MLP) neural networks, transformer neural networks, among others. For instance, convolutional neural networks (CNNs) are a type of feed-forward artificial neural network. Convolutional neural networks may include collections of artificial neurons that each have a receptive field (e.g., a spatially localized region of an input space) and that collectively tile an input space. RNNs work on the principle of saving the output of a layer and feeding this output back to the input to help in predicting an outcome of the layer. A GAN is a form of generative neural network that can learn patterns in input data so that the neural network model can generate new synthetic outputs that reasonably could have been from the original dataset. A GAN can include two neural networks that operate together, including a generative neural network that generates a synthesized output and a discriminative neural network that evaluates the output for authenticity. In MLP neural networks, data may be fed into an input layer, and one or more hidden layers provide levels of abstraction to the data. Predictions may then be made on an output layer based on the abstracted data.

Deep learning (DL) is an example of a machine learning technique and can be considered a subset of ML. Many DL approaches are based on a neural network, such as an RNN or a CNN, and utilize multiple layers. The use of multiple layers in deep neural networks can permit progressively higher-level features to be extracted from a given input of raw data. For example, the output of a first layer of artificial neurons becomes an input to a second layer of artificial neurons, the output of a second layer of artificial neurons becomes an input to a third layer of artificial neurons, and so on. Layers that are located between the input and output of the overall deep neural network are often referred to as hidden layers. The hidden layers learn (e.g., are trained) to transform an intermediate input from a preceding layer into a slightly more abstract and composite representation that can be provided to a subsequent layer, until a final or desired representation is obtained as the final output of the deep neural network.

As noted above, a neural network is an example of a machine learning system, and can include an input layer, one or more hidden layers, and an output layer. Data is provided from input nodes of the input layer, processing is performed by hidden nodes of the one or more hidden layers, and an output is produced through output nodes of the output layer. Deep learning networks typically include multiple hidden layers. Each layer of the neural network can include feature maps or activation maps that can include artificial neurons (or nodes). A feature map can include a filter, a kernel, or the like. The nodes can include one or more weights used to indicate an importance of the nodes of one or more of the layers. In some cases, a deep learning network can have a series of many hidden layers, with early layers being used to determine simple and low-level characteristics of an input, and later layers building up a hierarchy of more complex and abstract characteristics.

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases. Deep learning architectures may perform especially well when applied to problems that have a natural hierarchical structure. For example, the classification of motorized vehicles may benefit from first learning to recognize wheels, windshields, and other features. These features may be combined at higher layers in different ways to recognize cars, trucks, and airplanes.

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

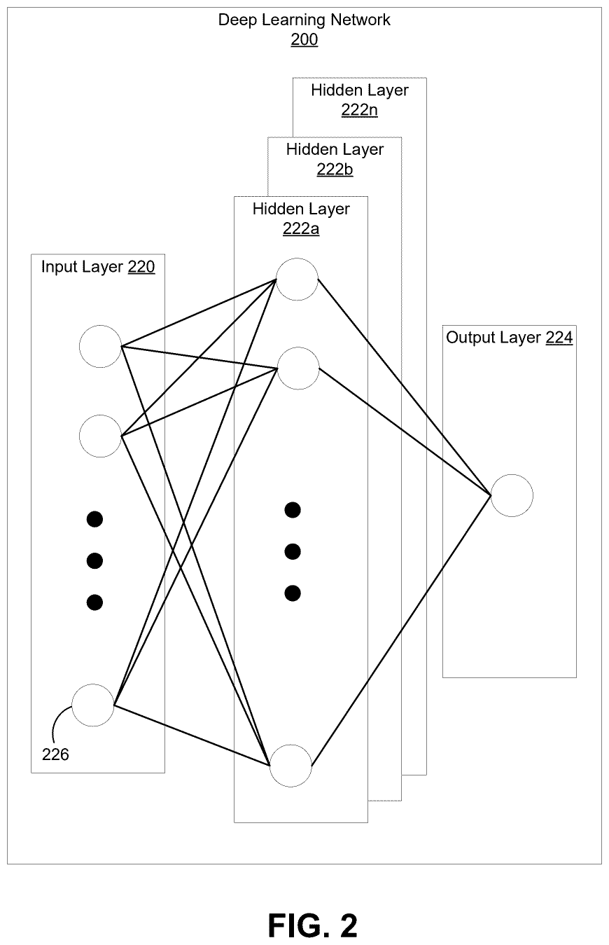

FIG. 2 is an illustrative example of a deep learning neural network 200 that can be used by the machine learning model. An input layer 220 includes input data. In some examples, the input layer 220 can include data representing the pixels of an input video frame. The neural network 200 includes multiple hidden layers 222a, 222b, through 222n. The hidden layers 222a, 222b, through 222n include “n” number of hidden layers, where “n” is an integer greater than or equal to one. The number of hidden layers can be made to include as many layers as needed for the given application. The neural network 200 further includes an output layer 224 that provides an output resulting from the processing performed by the hidden layers 222a, 222b, through 222n. In some examples, the output layer 224 can provide a classification for an object in an input video frame. The classification can include a class identifying the type of object (e.g., a person, a dog, a cat, or other object).

The neural network 200 is a multi-layer neural network of interconnected nodes. Each node can represent a piece of information. Information associated with the nodes is shared among the different layers and each layer retains information as information is processed. In some cases, the neural network 200 can include a feed-forward network, in which case there are no feedback connections where outputs of the network are fed back into itself. In some cases, the neural network 200 can include a recurrent neural network, which can have loops that allow information to be carried across nodes while reading in input.

Information can be exchanged between nodes through node-to-node interconnections between the various layers. Nodes of the input layer 220 can activate a set of nodes in the first hidden layer 222a. For example, as shown, each of the input nodes of the input layer 220 is connected to each of the nodes of the first hidden layer 222a. The nodes of the hidden layers 222a, 222b, through 222n can transform the information of each input node by applying activation functions to the information. The information derived from the transformation can then be passed to and can activate the nodes of the next hidden layer 222b, which can perform their own designated functions. Example functions include convolutional, up-sampling, data transformation, and/or any other suitable functions. The output of the hidden layer 222b can then activate nodes of the next hidden layer, and so on. The output of the last hidden layer 222n can activate one or more nodes of the output layer 224, at which an output is provided. In some cases, while nodes (e.g., node 226) in the neural network 200 are shown as having multiple output lines, a node has a single output and all lines shown as being output from a node represent the same output value.

In some cases, each node or interconnection between nodes can have a weight that is a set of parameters derived from the training of the neural network 200. Once the neural network 200 is trained, it can be referred to as a trained neural network, which can be used to classify one or more objects. For example, an interconnection between nodes can represent a piece of information learned about the interconnected nodes. The interconnection can have a tunable numeric weight that can be tuned (e.g., based on a training dataset), allowing the neural network 200 to be adaptive to inputs and able to learn as more and more data is processed.

The neural network 200 is pre-trained to process the features from the data in the input layer 220 using the different hidden layers 222a, 222b, through 222n in order to provide the output through the output layer 224. In an example in which the neural network 200 is used to identify objects in images, the neural network 200 can be trained using training data that includes both images and labels. For instance, training images can be input into the network, with each training image having a label indicating the classes of the one or more objects in each image (basically, indicating to the network what the objects are and what features they have). In some examples, a training image can include an image of a number 2, in which case the label for the image can be [0 0 1 0 0 0 0 0 0 0].

In some cases, the neural network 200 can adjust the weights of the nodes using a training process called backpropagation. Backpropagation can include a forward pass, a loss function, a backward pass, and a weight update. The forward pass, loss function, backward pass, and parameter update is performed for one training iteration. The process can be repeated for a certain number of iterations for each set of training images until the neural network 200 is trained well enough so that the weights of the layers are accurately tuned.

For the example of identifying objects in images, the forward pass can include passing a training image through the neural network 200. The weights are initially randomized before the neural network 200 is trained. The image can include, for example, an array of numbers representing the pixels of the image. Each number in the array can include a value from 0 to 255 describing the pixel intensity at that position in the array. In some examples, the array can include a 28×28×3 array of numbers with 28 rows and 28 columns of pixels and 3 color components (such as red, green, and blue, or luma and two chroma components, or the like).

For a first training iteration for the neural network 200, the output will likely include values that do not give preference to any particular class due to the weights being randomly selected at initialization. For example, if the output is a vector with probabilities that the object includes different classes, the probability value for each of the different classes may be equal or at least very similar (e.g., for ten possible classes, each class may have a probability value of 0.1). With the initial weights, the neural network 200 is unable to determine low level features and thus cannot make an accurate determination of what the classification of the object might be. A loss function can be used to analyze error in the output. Any suitable loss function definition can be used. An example of a loss function includes a mean squared error (MSE). The MSE is defined as

$${E}_{total} = \sum \frac{1}{2} {( target - output )}^{2} ,$$

which calculates the sum of one-half times a ground truth output (e.g., the actual answer) minus the predicted output (e.g., the predicted answer) squared. The loss can be set to be equal to the value of Eₜₒₜₐₗ.

The loss (or error) will be high for the first training images since the actual values will be much different than the predicted output. The goal of training is to minimize the amount of loss so that the predicted output is the same as the training label. The neural network 200 can perform a backward pass by determining which inputs (weights) most contributed to the loss of the network, and can adjust the weights so that the loss decreases and is eventually minimized.

A derivative of the loss with respect to the weights (denoted as dL/dW, where W are the weights at a particular layer) can be computed to determine the weights that contributed most to the loss of the network. After the derivative is computed, a weight update can be performed by updating all the weights of the filters. For example, the weights can be updated so that they change in the opposite direction of the gradient. The weight update can be denoted as

$$w = {w}_{i} - η \frac{dL}{dW} ,$$

where w denotes a weight, wᵢ denotes the initial weight, and η denotes a learning rate. The learning rate can be set to any suitable value, with a high learning rate including larger weight updates and a lower value indicating smaller weight updates.

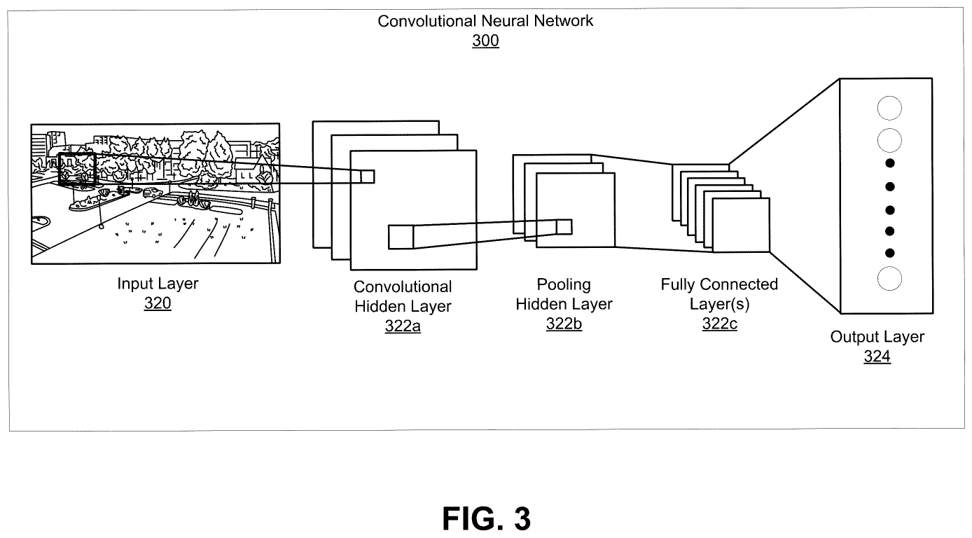

The neural network 200 can include any suitable deep network. As described previously, an example of a neural network 200 includes a convolutional neural network (CNN), which includes an input layer and an output layer, with multiple hidden layers between the input and out layers. An example of a CNN is described below with respect to FIG. 3. The hidden layers of a CNN include a series of convolutional, nonlinear, pooling (for downsampling), and fully connected layers. The neural network 200 can include any other deep network other than a CNN, such as an autoencoder, a deep belief nets (DBNs), a Recurrent Neural Networks (RNNs), among others.

FIG. 3 is an illustrative example of a convolutional neural network 300 (CNN 300). The input layer 320 of the CNN 300 includes data representing an image. For example, the data can include an array of numbers representing the pixels of the image, with each number in the array including a value from 0 to 255 describing the pixel intensity at that position in the array. Using the previous example from above, the array can include a 28×28×3 array of numbers with 28 rows and 28 columns of pixels and 3 color components (e.g., red, green, and blue, or luma and two chroma components, or the like). The image can be passed through a convolutional hidden layer 322a, an optional non-linear activation layer, a pooling hidden layer 322b, and fully connected hidden layers 322c to get an output at the output layer 324. While only one of each hidden layer is shown in FIG. 3, one of ordinary skill will appreciate that multiple convolutional hidden layers, non-linear layers, pooling hidden layers, and/or fully connected layers can be included in the CNN 300. As previously described, the output can indicate a single class of an object or can include a probability of classes that best describe the object in the image.

The first layer of the CNN 300 is the convolutional hidden layer 322a. The convolutional hidden layer 322a analyzes the image data of the input layer 320. Each node of the convolutional hidden layer 322a is connected to a region of nodes (pixels) of the input image called a receptive field. The convolutional hidden layer 322a can be considered as one or more filters (each filter corresponding to a different activation or feature map), with each convolutional iteration of a filter being a node or neuron of the convolutional hidden layer 322a. For example, the region of the input image that a filter covers at each convolutional iteration would be the receptive field for the filter. In some examples, if the input image includes a 28×28 array, and each filter (and corresponding receptive field) is a 5×5 array, then there will be 24×24 nodes in the convolutional hidden layer 322a. Each connection between a node and a receptive field for that node learns a weight and, in some cases, an overall bias such that each node learns to analyze its particular local receptive field in the input image. Each node of the hidden layer 322a will have the same weights and bias (called a shared weight and a shared bias). For example, the filter has an array of weights (numbers) and the same depth as the input. A filter will have a depth of 3 for the video frame example (according to three color components of the input image). An illustrative example size of the filter array is 5×5×3, corresponding to a size of the receptive field of a node.

The convolutional nature of the convolutional hidden layer 322a is due to each node of the convolutional layer being applied to its corresponding receptive field. For example, a filter of the convolutional hidden layer 322a can begin in the top-left corner of the input image array and can convolve around the input image. As noted above, each convolutional iteration of the filter can be considered a node or neuron of the convolutional hidden layer 322a. At each convolutional iteration, the values of the filter are multiplied with a corresponding number of the original pixel values of the image (e.g., the 5×5 filter array is multiplied by a 5×5 array of input pixel values at the top-left corner of the input image array). The multiplications from each convolutional iteration can be summed together to obtain a total sum for that iteration or node. The process is next continued at a next location in the input image according to the receptive field of a next node in the convolutional hidden layer 322a.

For example, a filter can be moved by a step amount to the next receptive field. The step amount can be set to 1 or other suitable amount. For example, if the step amount is set to 1, the filter will be moved to the right by 1 pixel at each convolutional iteration. Processing the filter at each unique location of the input volume produces a number representing the filter results for that location, resulting in a total sum value being determined for each node of the convolutional hidden layer 322a.

The mapping from the input layer to the convolutional hidden layer 322a is referred to as an activation map (or feature map). The activation map includes a value for each node representing the filter results at each locations of the input volume. The activation map can include an array that includes the various total sum values resulting from each iteration of the filter on the input volume. For example, the activation map will include a 24×24 array if a 5×5 filter is applied to each pixel (a step amount of 1) of a 28×28 input image. The convolutional hidden layer 322a can include several activation maps in order to identify multiple features in an image. The example shown in FIG. 3 includes three activation maps. Using three activation maps, the convolutional hidden layer 322a can detect three different kinds of features, with each feature being detectable across the entire image.

In some examples, a non-linear hidden layer can be applied after the convolutional hidden layer 322a. The non-linear layer can be used to introduce non-linearity to a system that has been computing linear operations. One illustrative example of a non-linear layer is a rectified linear unit (ReLU) layer. A ReLU layer can apply the function f(x)=max(0, x) to all of the values in the input volume, which changes all the negative activations to 0. The ReLU can thus increase the non-linear properties of the CNN 300 without affecting the receptive fields of the convolutional hidden layer 322a.

The pooling hidden layer 322b can be applied after the convolutional hidden layer 322a (and after the non-linear hidden layer when used). The pooling hidden layer 322b is used to simplify the information in the output from the convolutional hidden layer 322a. For example, the pooling hidden layer 322b can take each activation map output from the convolutional hidden layer 322a and generates a condensed activation map (or feature map) using a pooling function. Max-pooling is an example of a function performed by a pooling hidden layer. Other forms of pooling functions be used by the pooling hidden layer 322a, such as average pooling, L2-norm pooling, or other suitable pooling functions. A pooling function (e.g., a max-pooling filter, an L2-norm filter, or other suitable pooling filter) is applied to each activation map included in the convolutional hidden layer 322a. In the example shown in FIG. 3, three pooling filters are used for the three activation maps in the convolutional hidden layer 322a.

In some examples, max-pooling can be used by applying a max-pooling filter (e.g., having a size of 2×2) with a step amount (e.g., equal to a dimension of the filter, such as a step amount of 2) to an activation map output from the convolutional hidden layer 322a. The output from a max-pooling filter includes the maximum number in every sub-region that the filter convolves around. Using a 2×2 filter as an example, each unit in the pooling layer can summarize a region of 2×2 nodes in the previous layer (with each node being a value in the activation map). For example, four values (nodes) in an activation map will be analyzed by a 2×2 max-pooling filter at each iteration of the filter, with the maximum value from the four values being output as the “max” value. If such a max-pooling filter is applied to an activation filter from the convolutional hidden layer 322a having a dimension of 24×24 nodes, the output from the pooling hidden layer 322b will be an array of 12×12 nodes.

In some examples, an L2-norm pooling filter could also be used. The L2-norm pooling filter includes computing the square root of the sum of the squares of the values in the 2×2 region (or other suitable region) of an activation map (instead of computing the maximum values as is done in max-pooling), and using the computed values as an output.

Intuitively, the pooling function (e.g., max-pooling, L2-norm pooling, or other pooling function) determines whether a given feature is found anywhere in a region of the image, and discards the exact positional information. This can be done without affecting results of the feature detection because, once a feature has been found, the exact location of the feature is not as important as its approximate location relative to other features. Max-pooling (as well as other pooling methods) offer the benefit that there are many fewer pooled features, thus reducing the number of parameters needed in later layers of the CNN 300.

The final layer of connections in the network is a fully-connected layer that connects every node from the pooling hidden layer 322b to every one of the output nodes in the output layer 324. Using the example above, the input layer includes 28×28 nodes encoding the pixel intensities of the input image, the convolutional hidden layer 322a includes 3×24×24 hidden feature nodes based on application of a 5×5 local receptive field (for the filters) to three activation maps, and the pooling layer 322b includes a layer of 3×12×12 hidden feature nodes based on application of max-pooling filter to 2×2 regions across each of the three feature maps. Extending this example, the output layer 324 can include ten output nodes. In such an example, every node of the 3×12×12 pooling hidden layer 322b is connected to every node of the output layer 324.

The fully connected layer 322c can obtain the output of the previous pooling layer 322b (which should represent the activation maps of high-level features) and determines the features that most correlate to a particular class. For example, the fully connected layer 322c layer can determine the high-level features that most strongly correlate to a particular class, and can include weights (nodes) for the high-level features. A product can be computed between the weights of the fully connected layer 322c and the pooling hidden layer 322b to obtain probabilities for the different classes. For example, if the CNN 300 is being used to predict that an object in a video frame is a person, high values will be present in the activation maps that represent high-level features of people (e.g., two legs are present, a face is present at the top of the object, two eyes are present at the top left and top right of the face, a nose is present in the middle of the face, a mouth is present at the bottom of the face, and/or other features common for a person).

In some examples, the output from the output layer 324 can include an M-dimensional vector (in the prior example, M=10), where M can include the number of classes that the program has to choose from when classifying the object in the image. Other example outputs can also be provided. Each number in the N-dimensional vector can represent the probability the object is of a certain class. In some examples, if a 10-dimensional output vector represents ten different classes of objects is [0 0 0.05 0.8 0 0.15 0 0 0 0], the vector indicates that there is a 5% probability that the image is the third class of object (e.g., a dog), an 80% probability that the image is the fourth class of object (e.g., a human), and a 15% probability that the image is the sixth class of object (e.g., a kangaroo). The probability for a class can be considered a confidence level that the object is part of that class.

As previously mentioned, there has recently been an increased popularity of introducing bokeh (e.g., blur) effects into images (e.g., snapshot bokeh) or into video including a plurality of images (e.g., video bokeh). In photography, the term “bokeh” refers to the aesthetic quality of blur that is produced in out-of-focus parts of an image, whether in the foreground or background of the image, or both.

Bokeh can be introduced into an image by convolving the image with a kernel that corresponds to the image of an out-of-focus point source taken with a real camera. This convolution uses a kernel that depends upon the distance of each point in the image. Bokeh is a defocusing blur that can be achieved by performing convolution with a uniform disk or circle (e.g., a bokeh disc) to produce soft circles around highlights within the image.

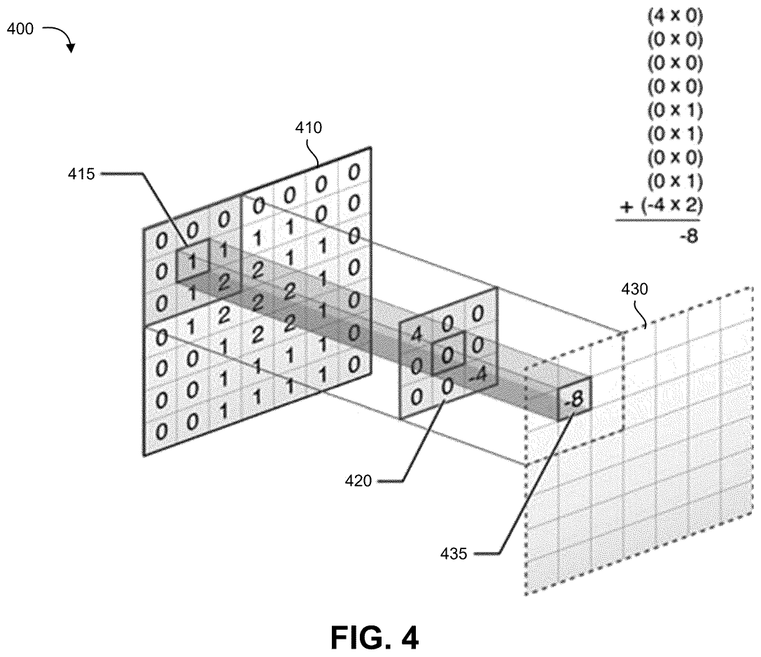

FIG. 4 shows an example of a convolutional operation using a kernel to introduce bokeh (e.g., blur) into an image. In particular, FIG. 4 is a diagram illustrating an example 400 of a convolutional operation using a kernel 420 to render bokeh (e.g., blur) in an image.

Convolution is an operation performed on two functions (e.g., f and g) to produce a third function. Convolution can operate in one dimension (1D) (e.g., for speech processing), in two dimensions (2D) (e.g., for image processing), or in three dimensions (3D) (e.g., for video processing). In image processing, convolution is the process of transforming an image (e.g., a source image, such as image 410) by applying a kernel (e.g., kernel 420) over each pixel and the pixel's local neighboring pixels across the entire image (e.g., image 410). The kernel (e.g., kernel 420) is a matrix of values whose size and values determine the transformation effect of the convolution process.

During operation of the convolution process, the kernel 420 is placed over each pixel (e.g., pixel 415) of the image 410, while ensuring that the full kernel 420 (e.g., the kernel matrix) is contained within the image 410. As the kernel 420 is placed over each pixel (e.g., pixel 415) in the image 410, each value of the kernel 420 can be multiplied with the corresponding pixel (e.g., pixel 415) in the image 410 that the kernel 420 is placed over. The resulting multiplied values can be summed together to produce a resulting value, which will become the new value of the center pixel (e.g., pixel 435 of a resultant image 430). This convolution process can be repeated across all of the pixels within the entire image 410.

For example, as shown in FIG. 4, a three by three (3×3) kernel (e.g., the kernel 420) is convolved with a seven by seven (7×7) matrix source image (e.g., the image 410). The center element of the kernel 420 is placed over the source pixel (e.g., pixel 415) of the image 410. The source pixel (e.g., pixel 415) can be replaced with a weighted sum of itself and surrounding pixels. The output is placed in the destination pixel value (e.g., pixel 435 of the resultant image 430).

In this example, at the first position, a “0” is in the source pixel of the image 410 and a “4” is in the kernel 420 (e.g., where 4×0 is 0). Moving to the next pixel in the image 410, a “0” is in the source pixel of the image 410 and a “0” is in the kernel (e.g., where 0×0 is 0). The process repeats for the remaining pixels in the image 410 covered by the kernel 420. Summing up all of these results gives “−8”. As such, the output of this convolution operation will be “−8”. This result can then be updated in the corresponding pixel 435 in the resultant image 430.

The output of the convolution process changes with the changing values of the kernel 420. Similar to how the values of the kernel 420 can be varied for different levels of effects (e.g., blur or bokeh effects), the size of the kernel 420 can also be modified to shape the effect of the convolution. By increasing the size of the kernel matrix (e.g., of the kernel 420), the spatial locality influencing each pixel's resulting value is increased as pixels from further away are being pulled into the equation.

Convolution is the key concept in CNNs. As previously mentioned, CNNs are a type of deep neural network. As shown in FIG. 3, a CNN can include a convolutional layer (e.g., convolutional hidden layer 322a), a pooling layer (e.g., pooling hidden layer 322b), and a fully-connected layer (e.g., fully-connected layer(s) 322c). At the convolutional layer, a CNN applies a convolution onto its inputs using a kernel matrix that it calibrates through training. For this reason, CNNs are good at feature matching in images and object classification. The convolutional layer parameters consist of a set of learnable kernels. Every kernel is small matrix that extends through the full depth of the input volume. During the forward pass, each kernel is convolved across the width and height of the input image, and dot products can be computed between the pixel values of the source image and the kernel at corresponding positions.

A blur map can be generated by dividing a disparity map into several layers. Each layer represents a range of disparity differences relative to the focal plane. This range can be determined by a factor κ, which is representative of the blur strength and is used to scale the disparity difference relative to the focal plane. The value at each location (i, j) in the blur map represents the blur radius to blur the corresponding pixel in the video frame (or image frame). The maximum possible blur radius can be capped (e.g., limited) to a predefined value.

In one or more examples, for generation of a blur map, one or more processors can compute deltaᵢⱼ=abs(dᵢⱼ−d_{focal}), where deltaᵢⱼ is the absolute disparity difference between the disparity dᵢⱼ at location (i,j) relative to the disparity at the focal plane d_{focal}. If deltaᵢⱼ=0, then blurmapᵢⱼ=0, since the pixels are located on the focal plane. If deltaᵢⱼ is greater than 0, then blurmapᵢⱼ=κ(deltaᵢⱼ−1)+1, where κ is a scaling factor representative of the blur strength.

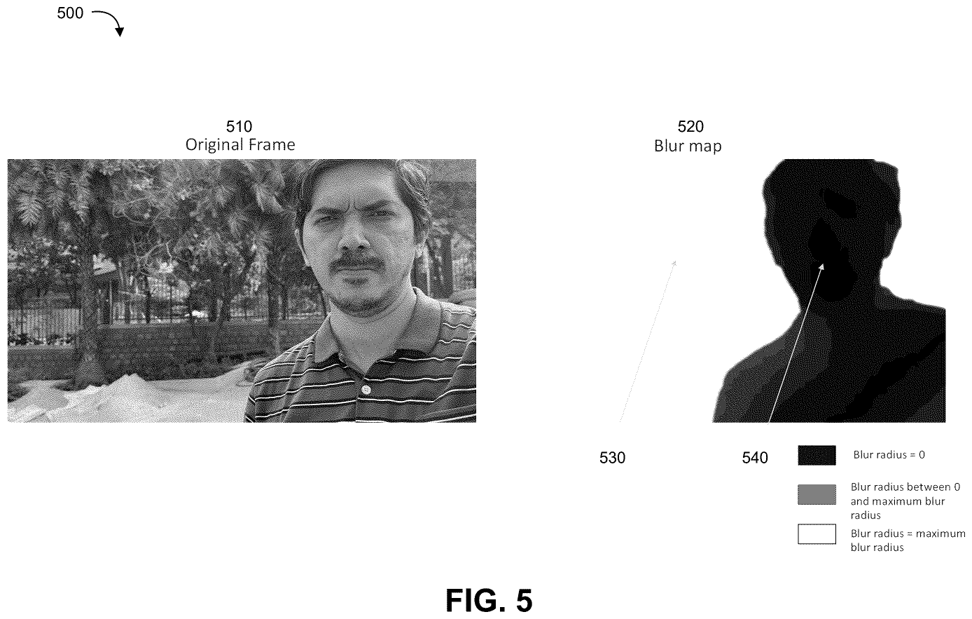

FIG. 5 shows an example of a blur map. In particular, FIG. 5 is a diagram illustrating an example 500 of a blur map 520 generated based on an image 510 of a scene. In FIG. 5, the blur map 520 is shown to include a region 530 blurred using a blur radius equal to the maximum blur radius. The blur map 520 is also shown to include a region 540 blurred using a blur radius equal to zero (0).

As previously mentioned, power and compute requirements for producing real time bokeh effects (e.g., for preview and streaming for snapshot or video recording) are significant. To reduce power and compute requirements, a sparse kernel may be employed instead of a dense kernel. Utilizing a sparse kernel instead of a dense kernel requires significantly less computational requirements for producing bokeh. However, using a sparse kernel at all pixel positions can result in undesirable artifacts.

In one or more aspects, the systems and techniques provide depth and content guided selection of a type of kernel (e.g., a dense kernel, which requires a high overhead; a sparse kernel, which requires a low overhead; or a one by one matrix kernel, which requires an even lower overhead) to produce a rendering of bokeh (e.g., blur) effects that is free of undesirable artifacts.

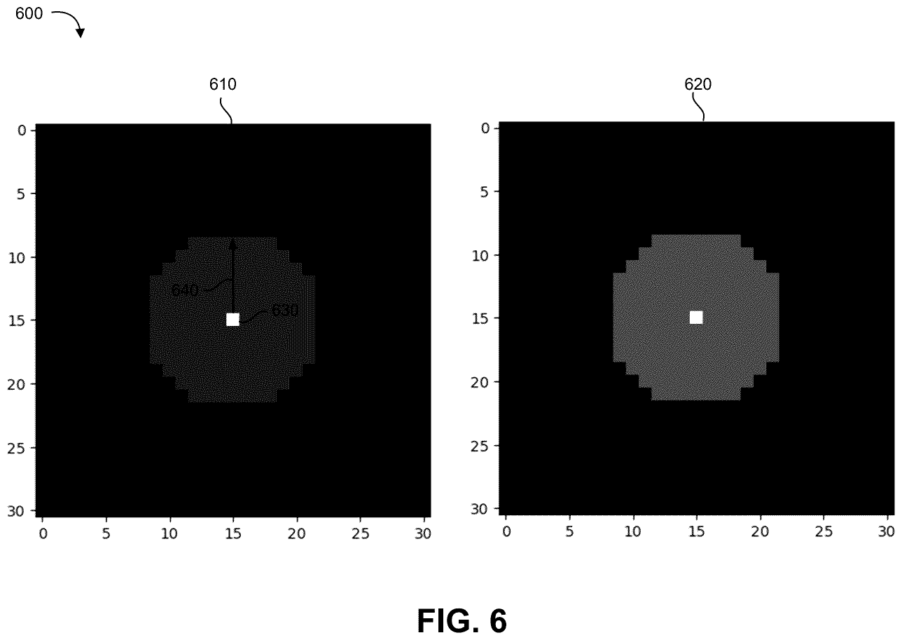

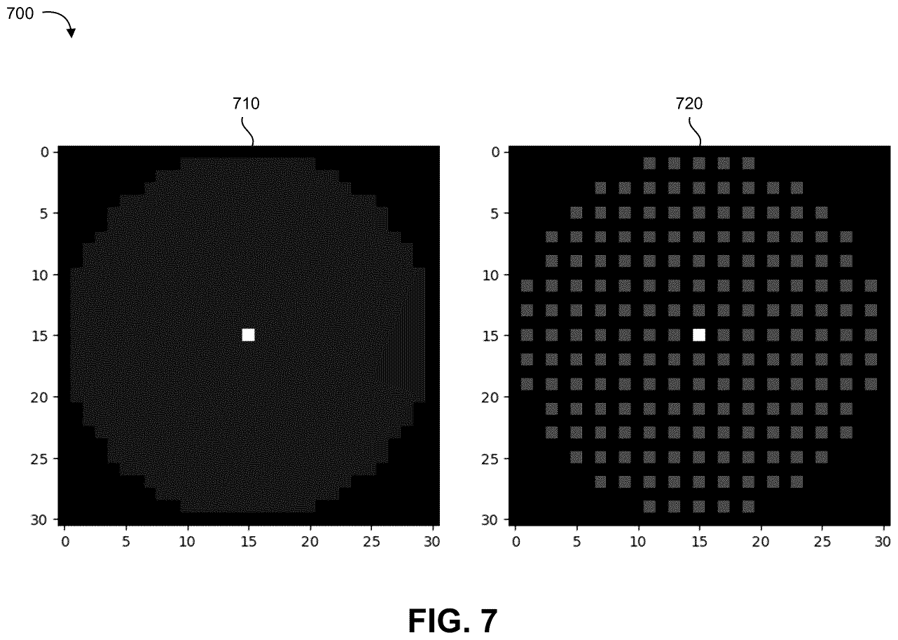

FIGS. 6 and 7 show examples of dense and sparse kernels. In particular, FIG. 6 is a diagram illustrating an example 600 of dense kernels 610, 620. In one or more examples, a kernel is densely populated with pixels (e.g., considered to be a dense kernel) when the blur radius is less than or equal to a blur radius threshold. In FIG. 6, an example of a dense kernel 610 is shown with a blur radius 640 (e.g., radiating from a center pixel 630) equal to seven (7). In one or more examples, the blur radius threshold may be equal to fourteen (14) and, as such, the blur radius 640 of 7 is less than the blur radius threshold of 14. FIG. 6 also shows an example of a dense kernel 620 that may be used for convolution.

FIG. 7 is a diagram illustrating an example 700 of a dense kernel 710 and a sparse kernel 720. In FIG. 7, an example of a dense kernel 610 is shown. In one or more examples, a kernel is sparsely populated with pixels (e.g., considered to be a sparse kernel) when the blur radius is greater than a blur radius threshold. In FIG. 7, an example of a sparse kernel 720 is shown with a blur radius equal to fifteen (15). In one or more examples, the blur radius threshold may be equal to fourteen (14) and, as such, the blur radius of 15 is greater than the blur radius threshold of 14. The sparse kernel 720 that may be used for convolution.

In one or more examples, the systems and techniques employ a one by one (1×1) matrix kernel if the disparity and intensity of the current pixel is same as (or similar to) the disparity and intensity of candidate neighboring pixels. In some examples, the systems and techniques employ a sparse kernel for blurring pixels that have the same (e.g., similar) disparity and nearly the same intensities in their candidate neighboring pixels, and the blur radius is greater than or equal to a blur radius threshold. In one or more examples, the systems and techniques employ a dense kernel for blurring all other pixels, where the disparity in the candidate neighboring pixels is non-uniform; the disparity in the candidate neighboring pixels is uniform, but the kernel is small (e.g., the blur radius is less than the blur radius threshold); or the disparity in the candidate neighboring pixels is uniform and the kernel is large (e.g., the blur radius is greater than or equal to the blur radius threshold), but intensities in the neighboring pixels vary drastically. In one or more examples, if a sparse kernel is used for all of the pixels in an image, it may lead to the resultant image having distinctly visible unwanted artifacts.

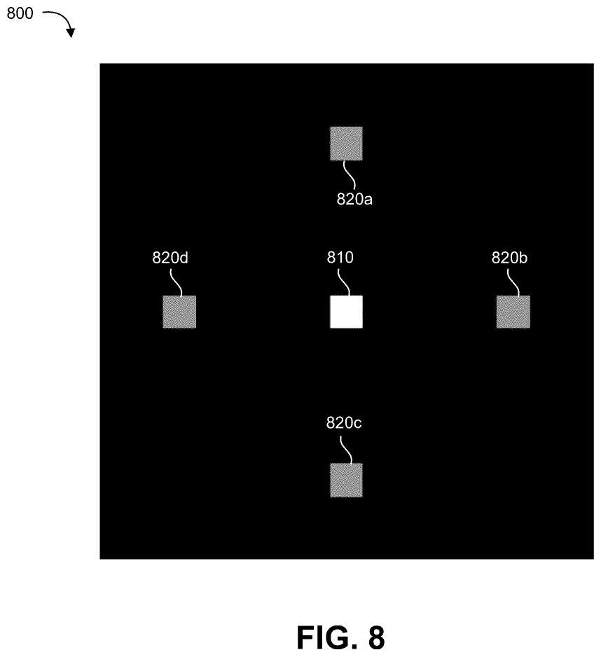

FIGS. 8, 9, and 10 show different examples of neighboring pixels of a pixel (e.g., a center pixel) of an image. In some examples, neighboring pixels of a pixel (e.g., a center pixel) can be located on a horizontal axis and a vertical axis around the pixel. FIG. 8 is a diagram illustrating an example 800 of a pixel 810 with neighboring pixels 820a, 820b, 820c, 820d located on a horizonal axis and a vertical axis. In FIG. 8, four (4) neighboring pixels 820a, 820b, 820c, 820d are shown. In other examples, more or less number of neighboring pixels than as shown in FIG. 8 may be employed.

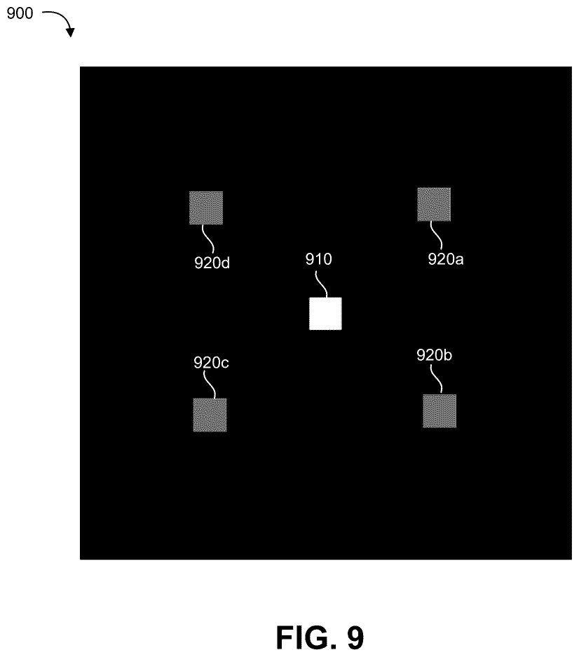

In one or more examples, neighboring pixels of a pixel (e.g., a center pixel) can be located on diagonal axes around the pixel. FIG. 9 is a diagram illustrating an example 900 of a pixel 910 with neighboring pixels 920a, 920b, 920c, 920d located on diagonal axes. In FIG. 9, four (4) neighboring pixels 920a, 920b, 920c, 920d are shown. In one or more examples, more or less number of neighboring pixels than as shown in FIG. 9 may be utilized.

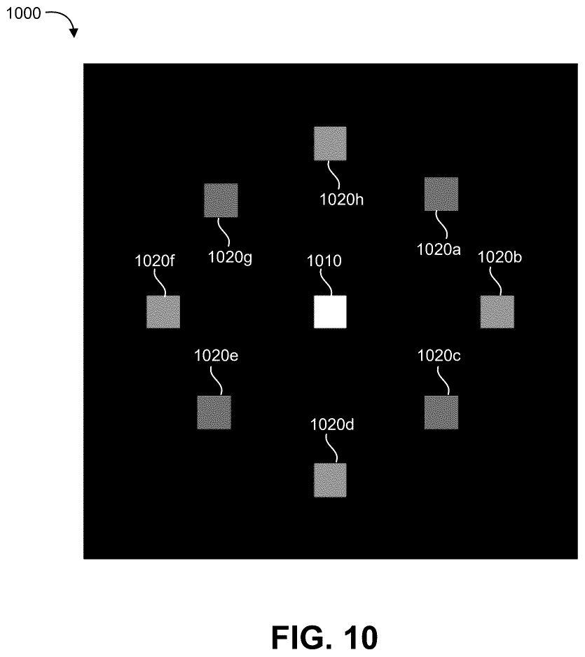

In some examples, neighboring pixels of a pixel (e.g., a center pixel) can be located on a horizontal axis, a vertical axis, and diagonal axes around the pixel. FIG. 10 is a diagram illustrating an example 1000 of a pixel 1010 with neighboring pixels 1020a, 1020b, 1020c, 1020d, 1020c, 1020f, 1020g, 1020h located on a horizonal axis, a vertical axis, and diagonal axes. In FIG. 10, eight (8) neighboring pixels 1020a, 1020b, 1020c, 1020d, 1020c, 1020f, 1020g, 1020h are shown. In other examples, more or less number of neighboring pixels than as shown in FIG. 10 may be employed.

In one or more aspects, one or more processors can, based on a characteristic of image data of an image, select a type of kernel (e.g., a dense kernel, a sparse kernel, or a one by one matrix kernel) to blur pixels of the image not located on the focal plane to render bokeh (e.g., blur effects) in an output image that is free of undesirable artifacts. The one or more processors can determine the characteristic of image data of an image. Based on the characteristic of image data, the one or more processors can determine a respective kernel from a plurality of kernels of different types to apply to each pixel of the image. In some examples, the characteristic of the image data can include a disparity of pixels in the image, an intensity of the pixels in the image, and/or a respective blur radius for each of the pixels in the image. In one or more examples, the plurality of kernels of different types can include at least a dense kernel, a sparse kernel comprising less number of pixels than the dense kernel, and a one by one (1×1) matrix kernel comprising one value. The one or more processors can apply the respective kernel to each pixel of the image to generate a blurred output image.

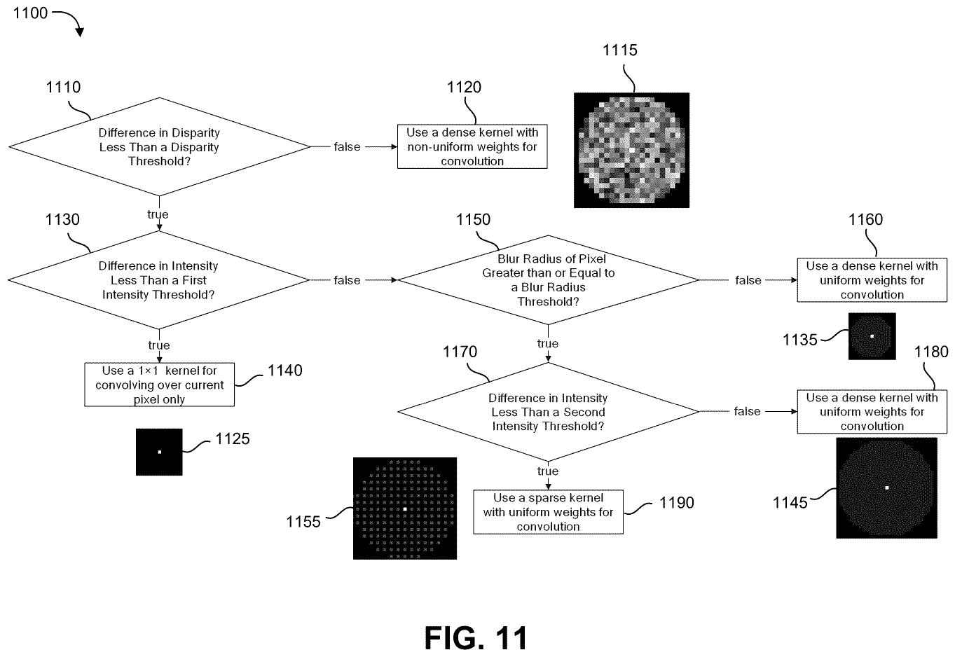

FIG. 11 shows an example of a process for blurring pixels not located on the focal plane. In particular, FIG. 11 is a diagram illustrating an example of a process 1100 for efficient sparse kernel based blurring (e.g., to render bokeh effects).

In FIG. 11, during operation of the process 1100, at decision block 1110, one or more processors can determine whether a difference in a disparity of a pixel (e.g., a center pixel, such as pixel 810 of FIG. 8) in an image and neighboring pixels (e.g., pixels 820a, 820b, 820c, 820d of FIG. 8) of the pixel (e.g., pixel 810 of FIG. 8) is less than a disparity threshold (e.g., which can indicate that the disparity of the pixel is the same or similar to the disparity of the neighboring pixels).

In one or more examples, the one or more processors may utilize a disparity map, based on the image, to determine the difference in disparity. The disparity is the inverse of the depth. As such, one or more processors may utilize a depth map, based on the image, to derive the disparity by taking the inverse of the depth and scaling the result.

If the one or more processors determines that the difference in the disparity of the pixel in the image and the neighboring pixels of the pixel is not less than (e.g., false) the disparity threshold, at block 1120, the one or more processors can use a dense kernel with non-uniform weights 1115 for convolution.

However, if the one or more processors determines that the difference in the disparity of the pixel in the image and the neighboring pixels of the pixel is less than (e.g., true) the disparity threshold, at decision block 1130, the one or more processors can determine whether a difference in an intensity of the pixel (e.g., a center pixel, such as pixel 810 of FIG. 8) in the image and the neighboring pixels (e.g., pixels 820a, 820b, 820c, 820d of FIG. 8) of the pixel (e.g., pixel 810 of FIG. 8) is less than a first intensity threshold (e.g., which can indicate that the intensity of the pixel is similar to or the same as the intensity of the neighboring pixels).

If the one or more processors determines that the difference in the intensity of the pixel in the image and the neighboring pixels of the pixel is less than (e.g., true) the first intensity threshold, at block 1140, the one or more processors can use a one by one matrix kernel 1125 for convolving over the pixel (e.g., pixel 810 of FIG. 8) only.

However, if the one or more processors determines that the difference in the intensity of a pixel in the image and the neighboring pixels of the pixel is not less than (e.g., false) the first intensity threshold, at decision block 1150, the one or more processors can determine whether a blur radius (e.g., seven) of the pixel (e.g., pixel 810 of FIG. 8) is greater than or equal to a blur radius threshold (e.g., 0.5 of a maximum blur radius).

If the one or more processors determines that the blur radius of the pixel (e.g., pixel 810 of FIG. 8) is not greater than or equal to (e.g., false) the blur radius threshold, at block 1160, the one or more processors can use a dense kernel with uniform weights 1135 for convolution.

However, if the one or more processors determines that the blur radius of the pixel (e.g., pixel 810 of FIG. 8) is greater than or equal to (e.g., true) the blur radius threshold, at decision block 1170, the one or more processors can determine whether a difference in the intensity of the pixel (e.g., pixel 810 of FIG. 8) in the image and the neighboring pixels (e.g., pixels 820a, 820b, 820c, 820d of FIG. 8) of the pixel (e.g., pixel 810 of FIG. 8) is less than a second intensity threshold (e.g., which can indicate that the intensity of the pixel is nearly the same or the same as the intensity of the neighboring pixels).

If the one or more processors determines that the difference in the intensity of the pixel in the image and the neighboring pixels of the pixel is not less than (e.g., false) the second intensity threshold, at block 1180, the one or more processors can use a dense kernel with uniform weights 1145 for convolution.

However, if the one or more processors determines that the difference in the intensity of the pixel in the image and the neighboring pixels of the pixel is less than (e.g., true) the second intensity threshold, at block 1190, the one or more processors can use a sparse kernel with uniform weights 1155 for convolution.

Disparity in the neighboring pixels is generally non-uniform at depth discontinuities. If the kernel weights are uniform, undesirable color halo effects may result in the output image due to color mixing. To avoid undesirable color halo effects in the output image, kernel weights should be non-uniform, when there is a variation of disparity around the central pixel.

Small kernels convolve over a small neighborhood of the central pixel such that using a sparse kernel (e.g., which entails skipping an intermediate pixel) can lead to undesirable artifacts in the output image. The main bottleneck to meeting compute requirements for shallow depth of field rendering is due to the use of large kernels. As such, using a sparse kernel or a one by one matrix kernel rather than a dense kernel is not required, when the kernel (e.g., a dense kernel) is small (e.g., the blur radius of the kernel is less than a blur radius threshold).

When both the disparity and the intensity in the neighboring pixels is uniform, then the blurred pixel intensity is equal to the original pixel intensity. As such, a one by one matrix kernel, which assigns a weight of one (1) to the central pixel can be used. When convolution is performed with using one by one matrix kernel, a blurred pixel intensity is equal to one (1) times the original pixel intensity, which is just equal to the original pixel intensity (e.g., blurred pixel intensity=1×original pixel intensity=original pixel intensity).

In one or more aspects, determining (e.g., by the one or more processors) the difference in the intensity of a pixel (e.g., center pixels) in an image and the neighboring pixels of the pixels can be based on determining a cosine similarity, a mean squared error, a mean absolute error, or a standard deviation between the intensity of the pixels and the intensity of the neighboring pixels of the pixel.

In one or more examples, pixel intensity refers to the brightness or color value of a pixel in an image. The red, green, blue (RGB) pixel intensity can be represented as a vector in 3D Euclidean space. To determine whether the intensity of the pixel is similar to, nearly the same, or the same as the intensity of the neighboring pixels, a cosine similarity can be computed between the RGB pixel intensity of the central pixel and the pixel intensities of the neighboring pixels. In one or more examples, if the cosine similarity is equal to one (1), a one by one matrix kernel can be used to compute the blurred pixel intensity. In some examples, if the cosine similarity is greater than or equal to a cosine similarity threshold, then the neighboring pixels over which the kernel convolves can be approximated to have similar intensities, and a sparse kernel can be used to compute the blurred pixel intensity.

In one or more examples, the cosine similarity can be expressed as:

$$cos θ = \frac{A \cdot B}{‖ A ‖ ‖ B ‖} = \frac{{A}_{1} {B}_{1} + {A}_{2} {B}_{2} + {A}_{3} {B}_{3}}{\sqrt{{{A}_{1}}^{2} + {{A}_{2}}^{2} + {{A}_{3}}^{2}} \sqrt{{{B}_{1}}^{2} + {{B}_{2}}^{2} + {{B}_{3}}^{2}}}$$

where A=[A₁, A₂, A₃]^{T} represents the RGB values corresponding to the intensity of the central pixel, and B=[B₁, B₂, B₃]^{T} represents the RGB values corresponding to the intensity of the neighboring pixels. Since the RGB values are non-negative, the cosine similarity would range between zero (0) and one (1) for this application.

In one or more examples, to determine whether the intensity of the pixel is similar to, nearly the same, or the same as the intensity of the neighboring pixels, a mean squared error can be computed between the RGB pixel intensity of the central pixel and the pixel intensities of the neighboring pixels. In some examples, if the mean squared error is equal to zero (0), a one by one matrix kernel can be used to compute the blurred pixel intensity. In one or more examples, if the mean squared error is less than or equal to a mean squared error threshold, then the neighboring pixels over which the kernel convolves can be approximated to have similar intensities, and a sparse kernel can be used to compute the blurred pixel intensity.

In one or more examples, the mean squared error can be expressed as MSE=|A−B|², where A=[A₁, A₂, A₃]^{T} represents the RGB values corresponding to the intensity of the central pixel, and B=[B₁, B₂, B₃]^{T} represents the RGB values corresponding to the intensity of the neighboring candidate pixel.

In some examples, to determine whether the intensity of the pixel is similar to, nearly the same, or the same as the intensity of the neighboring pixels, a mean absolute error can be computed between the RGB pixel intensity of the central pixel and the pixel intensities of the neighboring pixels. In one or more examples, if the mean absolute error is equal to zero (0), a one by one matrix kernel can be used to compute the blurred pixel intensity. In some examples, if the mean absolute error is less than or equal to a mean absolute error threshold, then the neighboring pixels over which the kernel convolves can be approximated to have similar intensities, and a sparse kernel can be used to compute the blurred pixel intensity.

In one or more examples, the mean absolute error can be expressed as MAE=|A−B|, where A=[A₁, A₂, A₃]^{T} represents the RGB values corresponding to the intensity of the central pixel, and B=[B₁, B₂, B₃]^{T} represents the RGB values corresponding to the intensity of the neighboring candidate pixel.

In one or more examples, to determine whether the intensity of the pixel is similar to, nearly the same, or the same as the intensity of the neighboring pixels, a standard deviation of the RGB pixel intensity of the central pixel and the pixel intensities of the neighboring pixels can be computed. In some examples, if the standard deviation is equal to zero (0), a one by one matrix kernel can be used to compute the blurred pixel intensity. In one or more examples, if the standard deviation is less than or equal to a standard deviation threshold, then the neighboring pixels over which the kernel convolves can be approximated to have similar intensities, and a sparse kernel can be used to compute the blurred pixel intensity.

In one or more examples, the standard deviation can be expressed as:

$$σ = \sqrt{\frac{1}{N} {\sum }_{i = 1}^{N} {( {x}_{i} - μ )}^{2}} where μ = \frac{1}{N} {\sum }_{i = 1}^{N} {x}_{i}$$

where x₁ represents the RGB values corresponding to the intensity of the central pixel, and x₂ . . . x_{N} represents the RGB values corresponding to the intensities of neighboring pixels.

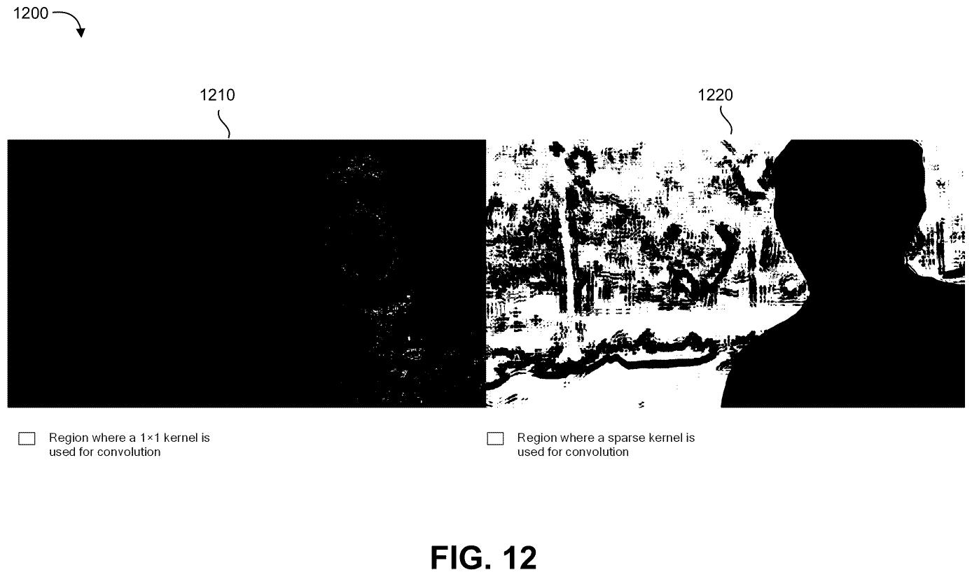

FIGS. 12, 13, 14, 15, and 16 show comparisons of example resultant frames from using different types of kernels for convolution. In particular, FIG. 12 is a diagram illustrating an example 1200 of regions (e.g., which are not on the focal plane) where a one by one matrix kernel is used and a sparse kernel is used, respectively. In FIG. 12, a frame 1210 is shown that includes regions where a one by one matrix kernel was used for convolution. For frame 1210, there is a uniform disparity, a uniform intensity, and a cosine similarity equal to one.

FIG. 12 also shows a frame 1220 that includes regions where a sparse kernel was used for convolution. For frame 1220, there is a uniform disparity, a similar intensity in the neighboring pixels, and the cosine similarity is greater than or equal to a cosine similarity threshold and is less than one.

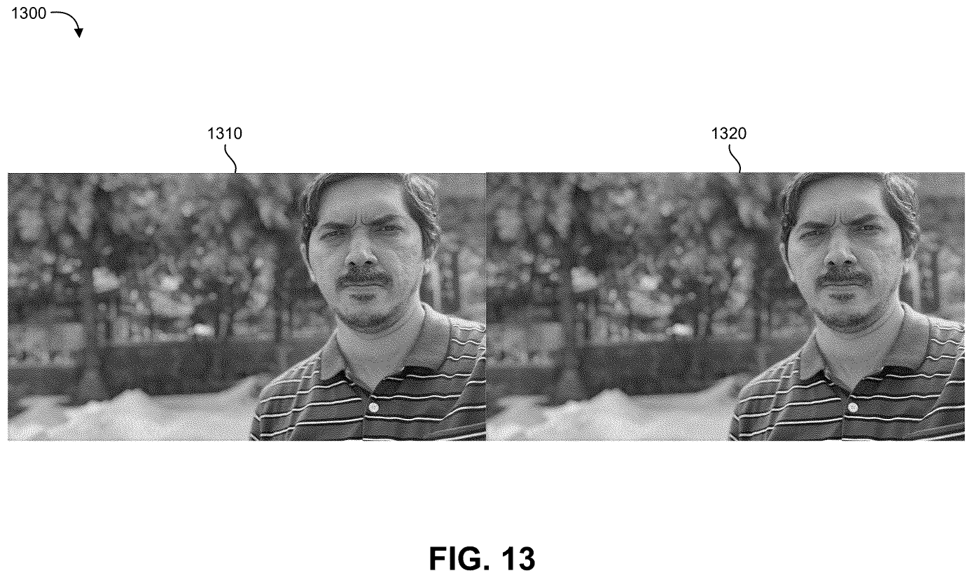

FIG. 13 is a diagram illustrating an example 1300 of bokeh frames 1310, 1320 for shallow depth of field rendering where a dense kernel is used and a combination of a dense kernel and a sparse kernel are used, respectively. In FIG. 13, a bokeh frame 1310 is shown where a dense kernel is used for convolution over all pixels in the image. FIG. 13 also shows a bokeh frame 1320 where, based on the systems and techniques (e.g., the process 1100 of FIG. 11), a combination of a dense kernel and a sparse kernel are used for convolution. As shown in FIG. 13, the image quality of bokeh frame 1310 and bokeh frame 1320 are very similar.

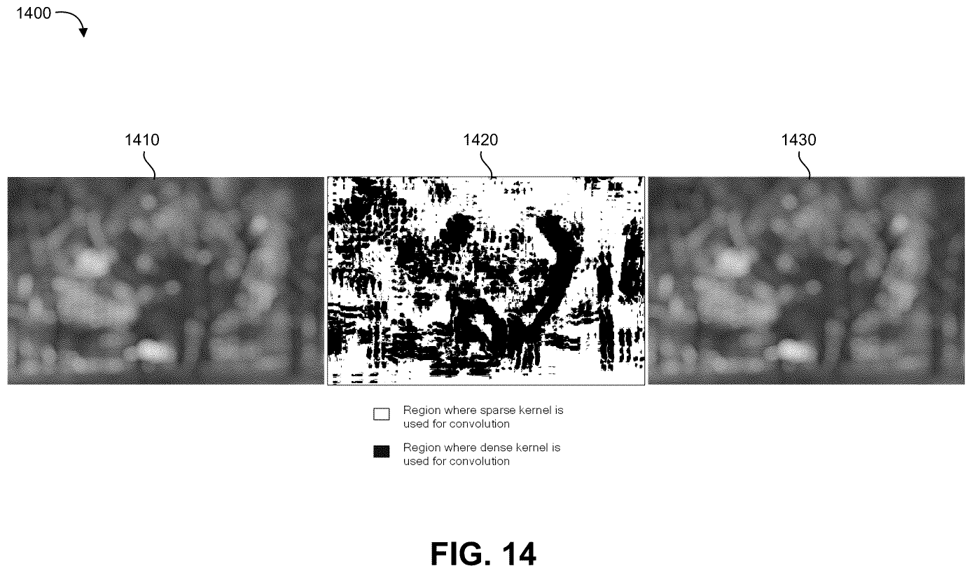

FIG. 14 is a diagram illustrating an example 1400 of bokeh frames 1410, 1430 for shallow depth of field rendering (e.g., of a zooming in on a region of trees) where a dense kernel is used and a combination of a dense kernel and a sparse kernel are used, respectively. In FIG. 14, a bokeh frame 1410 is shown where a dense kernel is used for convolution over all pixels in the image. FIG. 14 also shows a bokeh frame 1430 where, based on the systems and techniques (e.g., the process 1100 of FIG. 11), a combination of a dense kernel and a sparse kernel are used for convolution. As can be observed in FIG. 14, the image quality of the bokeh frames 1410, 1430 are very similar. FIG. 14 also shows a frame 1420 that includes regions where a sparse kernel was used for convolution and where a dense kernel was used for convolution.

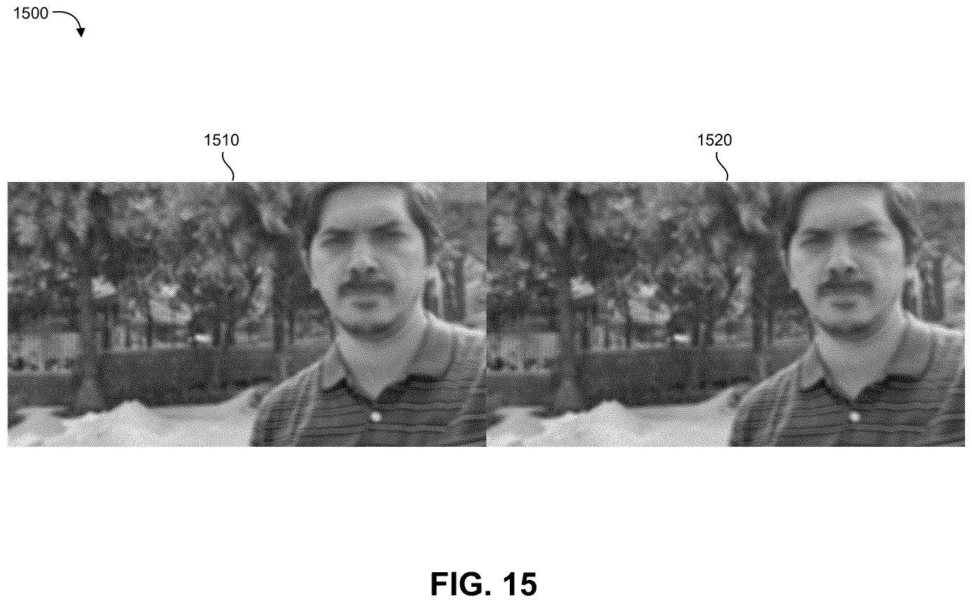

FIG. 15 is a diagram illustrating an example 1500 of box blurred frames 1510, 1520 where a dense kernel is used and a combination of a dense kernel and a sparse kernel are used, respectively. In FIG. 15, a box blurred frame 1510 is shown where a dense kernel is used for convolution over all pixels in the image. FIG. 15 also shows a bokeh frame 1520 where, based on the systems and techniques (e.g., the process 1100 of FIG. 11), a combination of a dense kernel (e.g., a 21×21 matrix) and a sparse kernel are used for convolution. As shown in FIG. 15, the image quality of box blurred frame 1510 and the box blurred frame 1520 are very similar.

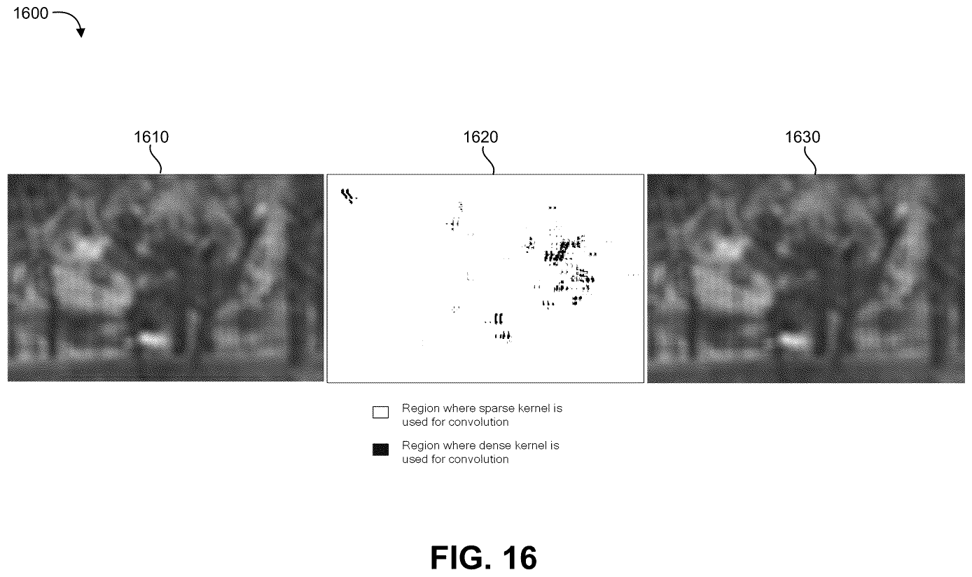

FIG. 16 is a diagram illustrating an example 1600 of box blurred frames 1610, 1630 where a dense kernel is used and a combination of a dense kernel and a sparse kernel are used, respectively. In FIG. 16, a box blurred frame 1610 is shown where a dense kernel is used for convolution over all pixels in the image. FIG. 16 also shows a box blurred frame 1630 where, based on the systems and techniques (e.g., the process 1100 of FIG. 11), a combination of a dense kernel (e.g., a 21×21 matrix) and a sparse kernel are used for convolution. As can be seen in FIG. 16, the image quality of the box blurred frame 1610 and box blurred frame 1630 are very similar. FIG. 16 also shows a frame 1620, which includes regions where a sparse kernel was used for convolution and where a dense kernel was used for convolution.

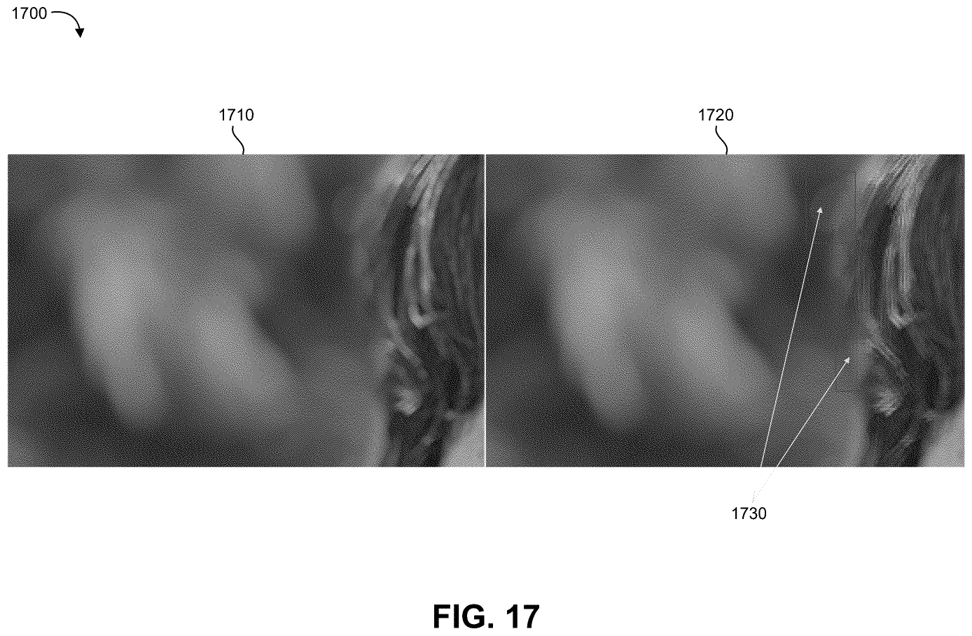

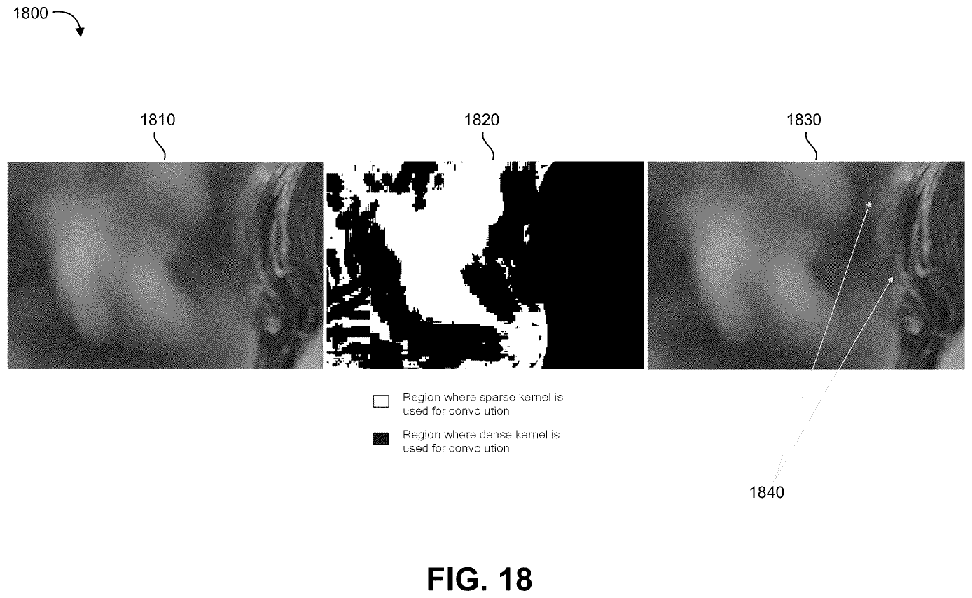

FIGS. 17 and 18 show comparisons of example resultant bokeh frames from using different types of kernels for convolution. In particular, FIG. 17 is a diagram illustrating examples 1700 of bokeh frames 1710, 1720 for shallow depth of field rendering where a dense kernel was used for all pixels within an image and a sparse kernel was used for all the pixels within the image, respectively. In FIG. 17, a bokeh frame 1710 is shown where a dense kernel is used for convolution over all pixels in the image. FIG. 17 also shows a bokeh frame 1720 where a sparse kernel is used for convolution over all pixels in the image. As shown in FIG. 17, the bokeh frame 1720 includes undesirable artifacts 1730.

FIG. 18 is a diagram illustrating examples 1800 of bokeh frames 1810, 1830 for shallow depth of field rendering where a dense kernel was used for all pixels within an image and a combination of a dense kernel and a sparse kernel was used, respectively. In FIG. 18, a bokeh frame 1810 is shown where a dense kernel is used for convolution over all pixels in the image. FIG. 18 also shows a bokeh frame 1830 where, based on the systems and techniques (e.g., the process 1100 of FIG. 11), a combination of a dense kernel and a sparse kernel are used for convolution. As can be observed in FIG. 18, unlike the bokeh frame 1720 of FIG. 17, the bokeh frame 1830 does not include artifacts in regions 1840. FIG. 18 also shows a frame 1820, which includes regions where a sparse kernel was used for convolution and where a dense kernel was used for convolution.

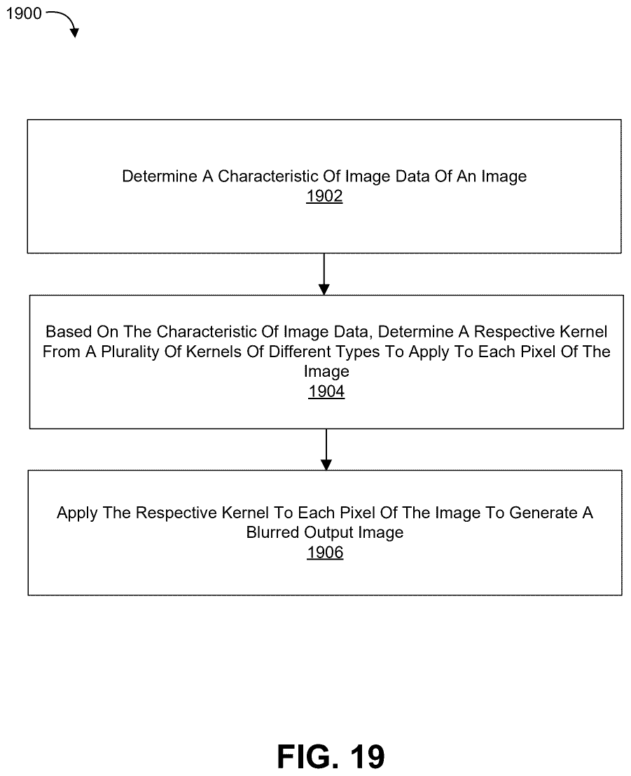

FIG. 19 is a flow chart illustrating an example of a process 1900 for image processing. The process 1900 can be performed by a computing device (e.g., a computing device or computing system 2000 of FIG. 20) or by a component or system (e.g., a chipset, one or more processors such as a neural processing unit (NPU), a neural signal processor (NSP), a digital signal processor (DSP), a graphics processing unit (GPU), a central processing unit (CPU), any combination thereof, and/or other processor(s), or other component or system) of the computing device. The operations of the process 1900 may be implemented as software components that are executed and run on one or more processors (e.g., processor 2010 of FIG. 20, or other processor(s)). Further, the transmission and reception of signals by the computing device in the process 1900 may be enabled, for example, by one or more antennas and/or one or more transceivers (e.g., wireless transceiver(s)).

At block 1902, the computing device (or component thereof) can determine a characteristic of image data of an image. In some aspects, the characteristic of the image data includes a disparity of pixels in the image, an intensity of the pixels in the image, a respective blur radius for each of the pixels in the image, any combination thereof, and/or other characteristic(s) of the image data.

At block 1904, the computing device (or component thereof) can determine, based on the characteristic of image data, a respective kernel from a plurality of kernels of different types to apply to each pixel of the image. In some aspects, the plurality of kernels of different types includes at least a dense kernel, a sparse kernel including less number of pixels than the dense kernel, and a one by one matrix kernel including one value.

In some aspects, to determine the respective kernel for each pixel of the image based on the characteristic of the image data, the computing device (or component thereof) can determine a difference in the disparity of each of the pixels in the image and a respective plurality of neighboring pixels of each of the pixels. In some cases, to determine the difference in the disparity of each of the pixels in the image and the respective plurality of neighboring pixels of each of the pixels, the computing device (or component thereof) can determine the difference in the disparity is less than a disparity threshold (e.g., at block 1110 of FIG. 11).

In some aspects, to determine the respective kernel for each pixel of the image based on the characteristic of the image data, the computing device (or component thereof) can determine a difference in the intensity of each of the pixels in the image and the respective plurality of neighboring pixels of each of the pixels. In some cases, to determine the difference in the intensity of each of the pixels in the image and the respective plurality of neighboring pixels of each of the pixels, the computing device (or component thereof) can determine the difference in the intensity is less than an intensity threshold (e.g., at block 1130 and/or at block 1170 of FIG. 11). In some aspects, the computing device (or component thereof) can determine the difference in the intensity of each of the pixels in the image and the respective plurality of neighboring pixels of each of the pixels based on determining a cosine similarity, a mean squared error, a mean absolute error, or a standard deviation between the intensity of each of the pixels in the image and the intensity of the respective plurality of neighboring pixels of each of the pixels.

In some cases, the respective plurality of neighboring pixels of each of the pixels can include a number of pixels (e.g., a first number of pixels) located on a horizontal axis and a vertical axis around an associated pixel (e.g., a center pixel) of the pixels (e.g., as shown in FIG. 8). In some cases, the respective plurality of neighboring pixels of each of the pixels can include a number of pixels (e.g., a second number of pixels) located on diagonal axes around the associated pixel of the pixels (e.g., as shown in FIG. 9). In some cases, the respective plurality of neighboring pixels of each of the pixels can include a number of pixels (e.g., a third number of pixels) located on the horizontal axis, the vertical axis, and the diagonal axes around the associated pixel of the pixels (e.g., as shown in FIG. 10).

In some aspects, to determine the respective kernel for each pixel of the image based on the characteristic of the image data, the computing device (or component thereof) can determine the respective blur radius of each of the pixels is greater than or equal to a blur radius threshold (e.g., at block 1150 of FIG. 11). In some cases, the blur radius threshold is equal to one-half of a maximum blur radius.

In some aspects, the computing device (or component thereof) can apply a one by one matrix kernel (e.g., at block 1140 of FIG. 11) to a pixel of the image based on a determination that a difference in a disparity of the pixel in the image and the respective plurality of neighboring pixels of the pixel is less than the disparity threshold (e.g., at block 1110 of FIG. 11) and a difference in an intensity of the pixel in the image and the respective plurality of neighboring pixels of the pixel is less than the intensity threshold (e.g., at block 1130 of FIG. 11).

In some aspects, the computing device (or component thereof) can apply a dense kernel (e.g., at block 1120 of FIG. 11) to a pixel of the image based on a determination that a difference in the disparity of the pixel in the image and the respective plurality of neighboring pixels of the pixel is not less than the disparity threshold (e.g., at block 1110 of FIG. 11) or a difference in an intensity of the pixel in the image and the respective plurality of neighboring pixels of the pixel is not less than the intensity threshold (e.g., at block 1170 of FIG. 11).

In some aspects, the computing device (or component thereof) can apply a sparse kernel (e.g., at block 1190 of FIG. 11) to a pixel of the image based on a determination that a difference in an intensity of the pixel in the image and the respective plurality of neighboring pixels of the pixel is less than the intensity threshold (e.g., at block 1170 of FIG. 11) and the respective blur radius of the pixel is greater than or equal to a blur radius threshold (e.g., at block 1150 of FIG. 11).

In some aspects, the computing device (or component thereof) can apply a dense kernel (e.g., at block 1130 of FIG. 11) to a pixel of the image based on a determination that a difference in an intensity of the pixel in the image and the respective plurality of neighboring pixels of the pixel is not less than the intensity threshold (e.g., at block 1130 of FIG. 11) or the respective blur radius of the pixel is not greater than or equal to a blur radius threshold (e.g., at block 1150 of FIG. 11).

At block 1906, the computing device (or component thereof) can apply the respective kernel to each pixel of the image to generate a blurred output image.

In some cases, the computing device of process 1900 may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, one or more network interfaces configured to communicate and/or receive the data, any combination thereof, and/or other component(s). The one or more network interfaces may be configured to communicate and/or receive wired and/or wireless data, including data according to the 3G, 4G, 5G, and/or other cellular standard, data according to the Wi-Fi (802.11×) standards, data according to the Bluetooth™ standard, data according to the Internet Protocol (IP) standard, and/or other types of data.

The components of the computing device of process 1900 can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein. The computing device may further include a display (as an example of the output device or in addition to the output device), a network interface configured to communicate and/or receive the data, any combination thereof, and/or other component(s). The network interface may be configured to communicate and/or receive Internet Protocol (IP) based data or other type of data.

The process 1900 is illustrated as a logical flow diagram, the operations of which represent a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the process 1900 may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 20 is a block diagram illustrating an example of a computing system 2000, which may be employed for efficient sparse kernel based blurring. In particular, FIG. 20 illustrates an example of computing system 2000, which can be for example any computing device making up internal computing system, a remote computing system, a camera, or any component thereof in which the components of the system are in communication with each other using connection 2005. Connection 2005 can be a physical connection using a bus, or a direct connection into processor 2010, such as in a chipset architecture. Connection 2005 can also be a virtual connection, networked connection, or logical connection.

In some aspects, computing system 2000 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example system 2000 includes at least one processing unit (CPU or processor) 2010 and connection 2005 that communicatively couples various system components including system memory 2015, such as read-only memory (ROM) 2020 and random access memory (RAM) 2025 to processor 2010. Computing system 2000 can include a cache 2012 of high-speed memory connected directly with, in close proximity to, or integrated as part of processor 2010.

Processor 2010 can include any general purpose processor and a hardware service or software service, such as services 2032, 2034, and 2036 stored in storage device 2030, configured to control processor 2010 as well as a special-purpose processor where software instructions are incorporated into the actual processor design. Processor 2010 may essentially be a completely self-contained computing system, containing multiple cores or processors, a bus, memory controller, cache, etc. A multi-core processor may be symmetric or asymmetric.

To enable user interaction, computing system 2000 includes an input device 2045, which can represent any number of input mechanisms, such as a microphone for speech, a touch-sensitive screen for gesture or graphical input, keyboard, mouse, motion input, speech, etc. Computing system 2000 can also include output device 2035, which can be one or more of a number of output mechanisms. In some instances, multimodal systems can enable a user to provide multiple types of input/output to communicate with computing system 2000.

Computing system 2000 can include communications interface 2040, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

The communications interface 2040 may also include one or more range sensors (e.g., LiDAR sensors, laser range finders, RF radars, ultrasonic sensors, and infrared (IR) sensors) configured to collect data and provide measurements to processor 2010, whereby processor 2010 can be configured to perform determinations and calculations needed to obtain various measurements for the one or more range sensors. In some examples, the measurements can include time of flight, wavelengths, azimuth angle, elevation angle, range, linear velocity and/or angular velocity, or any combination thereof. The communications interface 2040 may also include one or more Global Navigation Satellite System (GNSS) receivers or transceivers that are used to determine a location of the computing system 2000 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 2030 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 2030 can include software services, servers, services, etc., that when the code that defines such software is executed by the processor 2010, it causes the system to perform a function. In some aspects, a hardware service that performs a particular function can include the software component stored in a computer-readable medium in connection with the necessary hardware components, such as processor 2010, connection 2005, output device 2035, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories can include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, engines, circuits, and algorithm steps described in connection with the embodiments disclosed herein may be implemented as electronic hardware, computer software, firmware, or combinations thereof. To clearly illustrate this interchangeability of hardware and software, various illustrative components, blocks, engines, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as engines, modules, or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for encoding and decoding, or incorporated in a combined video encoder-decoder (CODEC).

Illustrative aspects of the disclosure include:

Aspect 1. An apparatus for image processing, the apparatus comprising: at least one memory; and at least one processor coupled to the at least one memory and configured to: determine a characteristic of image data of an image; based on the characteristic of image data, determine a respective kernel from a plurality of kernels of different types to apply to each pixel of the image; and apply the respective kernel to each pixel of the image to generate a blurred output image.

Aspect 2. The apparatus of Aspect 1, wherein the plurality of kernels of different types comprises at least a dense kernel, a sparse kernel comprising less number of pixels than the dense kernel, and a one by one matrix kernel comprising one value.

Aspect 3. The apparatus of any of Aspects 1 or 2, wherein the characteristic of the image data comprises at least one of a disparity of pixels in the image, an intensity of the pixels in the image, or a respective blur radius for each of the pixels in the image.

Aspect 4. The apparatus of Aspect 3, wherein, to determine the respective kernel for each pixel of the image based on the characteristic of the image data, the at least one processor is configured to determine a difference in the disparity of each of the pixels in the image and a respective plurality of neighboring pixels of each of the pixels.

Aspect 5. The apparatus of Aspect 4, wherein, to determine the difference in the disparity of each of the pixels in the image and the respective plurality of neighboring pixels of each of the pixels, the at least one processor is configured to determine the difference in the disparity is less than a disparity threshold.

Aspect 6. The apparatus of any of Aspects 4 or 5, wherein the respective plurality of neighboring pixels of each of the pixels comprises a first number of pixels located on a horizontal axis and a vertical axis around an associated pixel of the pixels, a second number of pixels located on diagonal axes around the associated pixel of the pixels, or a third number of pixels located on the horizontal axis, the vertical axis, and the diagonal axes around the associated pixel of the pixels.

Aspect 7. The apparatus of any of Aspects 3 to 6, wherein, to determine the respective kernel for each pixel of the image based on the characteristic of the image data, the at least one processor is configured to determine a difference in the intensity of each of the pixels in the image and a respective plurality of neighboring pixels of each of the pixels.

Aspect 8. The apparatus of Aspect 7, wherein, to determine the difference in the intensity of each of the pixels in the image and the respective plurality of neighboring pixels of each of the pixels, the at least one processor is configured to determine the difference in the intensity is less than an intensity threshold.

Aspect 9. The apparatus of any of Aspects 3 to 8, wherein the at least one processor is configured to determine a difference in an intensity of each of the pixels in the image and a respective plurality of neighboring pixels of each of the pixels based on determining a cosine similarity, a mean squared error, a mean absolute error, or a standard deviation between the intensity of each of the pixels in the image and the intensity of the respective plurality of neighboring pixels of each of the pixels.

Aspect 10. The apparatus of any of Aspects 3 to 9, wherein, to determine the respective kernel for each pixel of the image based on the characteristic of the image data, the at least one processor is configured to determine the respective blur radius of each of the pixels is greater than or equal to a blur radius threshold.

Aspect 11. The apparatus of Aspect 10, wherein the blur radius threshold is equal to one-half of a maximum blur radius.

Aspect 12. The apparatus of any of Aspects 3 to 11, wherein the at least one processor is configured to apply a sparse kernel to a pixel of the image based on a determination that a difference in an intensity of the pixel in the image and a respective plurality of neighboring pixels of the pixel is less than an intensity threshold and the respective blur radius of the pixel is greater than or equal to a blur radius threshold.

Aspect 13. The apparatus of any of Aspects 3 to 12, wherein the at least one processor is configured to apply a dense kernel to a pixel of the image based on a determination that a difference in an intensity of the pixel in the image and a respective plurality of neighboring pixels of the pixel is not less than an intensity threshold or the respective blur radius of the pixel is not greater than or equal to a blur radius threshold.

Aspect 14. The apparatus of any of Aspects 3 to 13, wherein the at least one processor is configured to apply a one by one matrix kernel to a pixel of the image based on a determination that a difference in a disparity of the pixel in the image and a respective plurality of neighboring pixels of the pixel is less than a disparity threshold and a difference in an intensity of the pixel in the image and the respective plurality of neighboring pixels of the pixel is less than an intensity threshold.

Aspect 15. The apparatus of any of Aspects 3 to 14, wherein the at least one processor is configured to apply a dense kernel to a pixel of the image based on a determination that a difference in the disparity of the pixel in the image and a respective plurality of neighboring pixels of the pixel is not less than a disparity threshold or a difference in an intensity of the pixel in the image and the respective plurality of neighboring pixels of the pixel is not less than an intensity threshold.

Aspect 16. A method for image processing, the method comprising: determining a characteristic of image data of an image; based on the characteristic of image data, determining a respective kernel from a plurality of kernels of different types to apply to each pixel of the image; and applying the respective kernel to each pixel of the image to generate a blurred output image.

Aspect 17. The method of Aspect 16, wherein the plurality of kernels of different types comprises at least a dense kernel, a sparse kernel comprising less number of pixels than the dense kernel, and a one by one matrix kernel comprising one value.

Aspect 18. The method of any of Aspects 16 or 17, wherein the characteristic of the image data comprises at least one of a disparity of pixels in the image, an intensity of the pixels in the image, or a respective blur radius for each of the pixels in the image.

Aspect 19. The method of Aspect 18, wherein determining the respective kernel for each pixel of the image based on the characteristic of the image data comprises determining a difference in the disparity of each of the pixels in the image and a respective plurality of neighboring pixels of each of the pixels.

Aspect 20. The method of Aspect 19, wherein determining the difference in the disparity of each of the pixels in the image and the respective plurality of neighboring pixels of each of the pixels comprises determining the difference in the disparity is less than a disparity threshold.

Aspect 21. The method of any of Aspects 19 or 20, wherein the respective plurality of neighboring pixels of each of the pixels comprises a first number of pixels located on a horizontal axis and a vertical axis around an associated pixel of the pixels, a second number of pixels located on diagonal axes around the associated pixel of the pixels, or a third number of pixels located on the horizontal axis, the vertical axis, and the diagonal axes around the associated pixel of the pixels.

Aspect 22. The method of any of Aspects 18 to 21, wherein determining the respective kernel for each pixel of the image based on the characteristic of the image data comprises determining a difference in the intensity of each of the pixels in the image and a respective plurality of neighboring pixels of each of the pixels.

Aspect 23. The method of Aspect 22, wherein determining the difference in the intensity of each of the pixels in the image and the respective plurality of neighboring pixels of each of the pixels comprises determining the difference in the intensity is less than an intensity threshold.

Aspect 24. The method of any of Aspects 18 to 23, further comprising determining a difference in an intensity of each of the pixels in the image and a respective plurality of neighboring pixels of each of the pixels based on determining a cosine similarity, a mean squared error, a mean absolute error, or a standard deviation between the intensity of each of the pixels in the image and the intensity of the respective plurality of neighboring pixels of each of the pixels.

Aspect 25. The method of any of Aspects 18 to 24, wherein determining the respective kernel for each pixel of the image based on the characteristic of the image data comprises determining the respective blur radius of each of the pixels is greater than or equal to a blur radius threshold.

Aspect 26. The method of Aspect 25, wherein the blur radius threshold is equal to one-half of a maximum blur radius.

Aspect 27. The method of any of Aspects 18 to 26, further comprising applying a sparse kernel to a pixel of the image based on a determination that a difference in an intensity of the pixel in the image and a respective plurality of neighboring pixels of the pixel is less than an intensity threshold and the respective blur radius of the pixel is greater than or equal to a blur radius threshold.

Aspect 28. The method of any of Aspects 18 to 27, further comprising applying a dense kernel to a pixel of the image based on a determination that a difference in an intensity of the pixel in the image and a respective plurality of neighboring pixels of the pixel is not less than an intensity threshold or the respective blur radius of the pixel is not greater than or equal to a blur radius threshold.

Aspect 29. The method of any of Aspects 18 to 28, further comprising applying a one by one matrix kernel to a pixel of the image based on a determination that a difference in a disparity of the pixel in the image and a respective plurality of neighboring pixels of the pixel is less than a disparity threshold and a difference in an intensity of the pixel in the image and the respective plurality of neighboring pixels of the pixel is less than an intensity threshold.

Aspect 30. The method of any of Aspects 18 to 29, further comprising applying a dense kernel to a pixel of the image based on a determination that a difference in the disparity of the pixel in the image and a respective plurality of neighboring pixels of the pixel is not less than a disparity threshold or a difference in an intensity of the pixel in the image and the respective plurality of neighboring pixels of the pixel is not less than an intensity threshold.

Aspect 31. A non-transitory computer-readable medium having stored thereon instructions that, when executed by at least one processor, cause the at least one processor to perform operations according to any of Aspects 16 to 30.

Aspect 32. An apparatus for image processing, the apparatus comprising one or more means for performing operations according to any of Aspects 16 to 30.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.”

What is claimed is:

1. An apparatus for image processing, the apparatus comprising:
at least one memory; and
at least one processor coupled to the at least one memory and configured to:
determine a characteristic of image data of an image;
based on the characteristic of image data, determine a respective kernel from a plurality of kernels of different types to apply to each pixel of the image; and
apply the respective kernel to each pixel of the image to generate a blurred output image.

2. The apparatus of claim 1, wherein the plurality of kernels of different types comprises at least a dense kernel, a sparse kernel comprising less number of pixels than the dense kernel, and a one by one matrix kernel comprising one value.

3. The apparatus of claim 1, wherein the characteristic of the image data comprises at least one of a disparity of pixels in the image, an intensity of the pixels in the image, or a respective blur radius for each of the pixels in the image.

4. The apparatus of claim 3, wherein, to determine the respective kernel for each pixel of the image based on the characteristic of the image data, the at least one processor is configured to determine a difference in the disparity of each of the pixels in the image and a respective plurality of neighboring pixels of each of the pixels.

5. The apparatus of claim 4, wherein, to determine the difference in the disparity of each of the pixels in the image and the respective plurality of neighboring pixels of each of the pixels, the at least one processor is configured to determine the difference in the disparity is less than a disparity threshold.

6. The apparatus of claim 4, wherein the respective plurality of neighboring pixels of each of the pixels comprises a first number of pixels located on a horizontal axis and a vertical axis around an associated pixel of the pixels, a second number of pixels located on diagonal axes around the associated pixel of the pixels, or a third number of pixels located on the horizontal axis, the vertical axis, and the diagonal axes around the associated pixel of the pixels.

7. The apparatus of claim 3, wherein, to determine the respective kernel for each pixel of the image based on the characteristic of the image data, the at least one processor is configured to determine a difference in the intensity of each of the pixels in the image and a respective plurality of neighboring pixels of each of the pixels.

8. The apparatus of claim 7, wherein, to determine the difference in the intensity of each of the pixels in the image and the respective plurality of neighboring pixels of each of the pixels, the at least one processor is configured to determine the difference in the intensity is less than an intensity threshold.

9. The apparatus of claim 3, wherein the at least one processor is configured to determine a difference in an intensity of each of the pixels in the image and a respective plurality of neighboring pixels of each of the pixels based on determining a cosine similarity, a mean squared error, a mean absolute error, or a standard deviation between the intensity of each of the pixels in the image and the intensity of the respective plurality of neighboring pixels of each of the pixels.

10. The apparatus of claim 3, wherein, to determine the respective kernel for each pixel of the image based on the characteristic of the image data, the at least one processor is configured to determine the respective blur radius of each of the pixels is greater than or equal to a blur radius threshold.

11. The apparatus of claim 10, wherein the blur radius threshold is equal to one-half of a maximum blur radius.

12. The apparatus of claim 3, wherein the at least one processor is configured to apply a sparse kernel to a pixel of the image based on a determination that a difference in an intensity of the pixel in the image and a respective plurality of neighboring pixels of the pixel is less than an intensity threshold and the respective blur radius of the pixel is greater than or equal to a blur radius threshold.

13. The apparatus of claim 3, wherein the at least one processor is configured to apply a dense kernel to a pixel of the image based on a determination that a difference in an intensity of the pixel in the image and a respective plurality of neighboring pixels of the pixel is not less than an intensity threshold or the respective blur radius of the pixel is not greater than or equal to a blur radius threshold.

14. The apparatus of claim 3, wherein the at least one processor is configured to apply a one by one matrix kernel to a pixel of the image based on a determination that a difference in a disparity of the pixel in the image and a respective plurality of neighboring pixels of the pixel is less than a disparity threshold and a difference in an intensity of the pixel in the image and the respective plurality of neighboring pixels of the pixel is less than an intensity threshold.

15. The apparatus of claim 3, wherein the at least one processor is configured to apply a dense kernel to a pixel of the image based on a determination that a difference in the disparity of the pixel in the image and a respective plurality of neighboring pixels of the pixel is not less than a disparity threshold or a difference in an intensity of the pixel in the image and the respective plurality of neighboring pixels of the pixel is not less than an intensity threshold.

16. A method for image processing, the method comprising:
determining a characteristic of image data of an image;
based on the characteristic of image data, determining a respective kernel from a plurality of kernels of different types to apply to each pixel of the image; and
applying the respective kernel to each pixel of the image to generate a blurred output image.

17. The method of claim 16, wherein the plurality of kernels of different types comprises at least a dense kernel, a sparse kernel comprising less number of pixels than the dense kernel, and a one by one matrix kernel comprising one value.

18. The method of claim 16, wherein the characteristic of the image data comprises at least one of a disparity of pixels in the image, an intensity of the pixels in the image, or a respective blur radius for each of the pixels in the image.

19. The method of claim 18, wherein determining the respective kernel for each pixel of the image based on the characteristic of the image data comprises determining a difference in the disparity of each of the pixels in the image and a respective plurality of neighboring pixels of each of the pixels.

20. The method of claim 18, wherein determining the respective kernel for each pixel of the image based on the characteristic of the image data comprises determining a difference in the intensity of each of the pixels in the image and a respective plurality of neighboring pixels of each of the pixels.
